(19) United States
(12) Patent Application Publication
(10) Pub. No.: US 2013/0230931 A1
(43) Pub. Date: Sep. 5, 2013

(54) TARGET SUBSTANCE DETECTING APPARATUS, AND TARGET SUBSTANCE DETECTING METHOD

(71) Applicants: Keisuke Yokoyama, Fujisawa-shi (JP); Hideki Furukawa, Fujisawa-shi (JP); Kunihiko Sasao, Fujisawa-shi (JP); Nobuko Okutani, Fujisawa-shi (JP); Toshiaki Oguchi, Fujisawa-shi (JP)

(72) Inventors: Keisuke Yokoyama, Fujisawa-shi (JP); Hideki Furukawa, Fujisawa-shi (JP); Kunihiko Sasao, Fujisawa-shi (JP); Nobuko Okutani, Fujisawa-shi (JP); Toshiaki Oguchi, Fujisawa-shi (JP)

(73) Assignee: NSK LTD., Shinagawa-ku, Tokyo (JP)

(21) Appl. No.: 13/581,516

(22) PCT Filed: Mar. 1, 2012
(86) PCT No.: PCT/JP2012/055245

§ 371 Date: Aug. 28, 2012

(51) Int. Cl. G01N 21/17

(52) U.S. Cl. CPC G01N 21/17
USPC 436/501; 422/69

(57) ABSTRACT

A target substance detecting apparatus includes a photonic crystal biosensor configured to include a photonic crystal, which has a reflection surface including concave portions and convex portions formed regularly on its surface, covered by a metal film, and reflecting light irradiated to the reflection surface; an optical detecting unit configured to irradiate parallel light to the reflection surface, and to detect reflected light of the parallel light reflected on the reflection surface; and a processing unit configured to obtain a wavelength at an extreme value of the reflected light detected by the optical detecting unit, and to detect at least whether the target substance is present or not based upon a shift of the obtained wavelength at the extreme value.

### TECHNICAL FIELD

The present invention relates to a target substance detecting apparatus that detects a target substance, and a target substance detecting method.

### BACKGROUND ART

There has been known a biosensor using a photonic crystal as a unit for detecting a target substance such as protein or a cell or for measuring a concentration thereof (e.g., Non Patent Literature 1). In this technique, light is irradiated to a photonic crystal substrate having a metal thin film formed thereon, and the reflected light is observed, whereby a concentration of a target substance, that is a subject to be detected, is measured.

### CITATION LIST

### Non Patent Literature

Non Patent Literature 1: “Development of a mass-producible on-chip plasmonic nanohole array biosensor”: Kohei Nakamoto, Ryoji Kurita, Osamu Niwa, Toshiyuki Fujiicd and Munehiro Nishida, Received 20 Jul. 2011, Accepted 27 Sep. 2011

### SUMMARY OF INVENTION

### Technical Problem

The biosensor described in Non Patent Literature 1 irradiates light to the photonic crystal substrate with a bundle fiber formed by bundling plural optical fibers. The light emitted from the bundle fiber diffuses with a certain angle, so that the intensity of the reflected light reflected on the photonic crystal substrate is extremely low. Therefore, the biosensor described in Non Patent Literature 1 might have deteriorated detection accuracy for the target substance.

The present invention aims to provide a target substance detecting apparatus and a target substance detecting method that can accurately detect a target substance.

### Solution to Problem

According to a first aspect of the present invention, a target substance detecting apparatus includes: a target substance trapping unit configured to include a structure, which has a reflection surface including concave portions and convex portions formed regularly on its surface, covered by a metal film, and trapping a target substance, the structure reflecting light irradiated to the reflection surface;

an optical detecting unit configured to irradiate parallel light to the reflection surface, and to detect reflected light of the parallel light reflected on the reflection surface; and a processing unit configured to obtain a wavelength at an extreme value of the reflected light detected by the optical detecting unit, and to detect at least whether the target substance is present or not based upon a shift of the obtained wavelength at the extreme value.

According to another aspect of the present invention, the target substance trapping unit includes a target substance trapping substance that is fixed on the reflection surface for trapping the target substance.

According to another aspect of the present invention, in the target substance trapping unit, the reflection surface on which a target substance of the same type as the target substance, which is the subject to be detected, is fixed in a constant amount is brought into contact with a mixture of a target substance trapping substance, which specifically reacts with the target substance fixed on the reflection surface, in a known amount, the target substance that is the subject to be detected, and a sample containing the target substance that is the subject to be detected.

According to another aspect of the present invention, the outermost surface of the metal film is gold.

According to another aspect of the present invention, the thickness of the metal film is 30 nm or more and 1000 nm or less.

According to another aspect of the present invention, the optical detecting unit includes: a first optical fiber that guides the light from the light source; a collimator lens that makes the light emitted from the first optical fiber the parallel light; and a second optical fiber that receives the reflected light, and guides the received light to a light-receiving unit.

According to another aspect of the present invention, the first optical fiber and the second optical fiber are integral on an emission side of the first optical fiber and an incident side of the second optical fiber.

According to another aspect of the present invention, the structure is a photonic crystal.

According to a second aspect of the present invention, a target substance detecting apparatus includes: a target substance trapping unit configured to include a photonic crystal, which has a reflection surface including concave portions and convex portions formed regularly on its surface, covered by a metal film, and trapping a target substance, the structure reflecting light irradiated to the reflection surface; an optical detecting unit configured to irradiate parallel light to the reflection surface, and to detect reflected light of the parallel light reflected on the reflection surface; and a processing unit configured to obtain a wavelength at an extreme value of the reflected light detected by the optical detecting unit, and to obtain a concentration of the target substance based upon a shift of the obtained wavelength at the extreme value.

According to another aspect of the present invention, the target substance trapping unit includes a target substance trapping substance that is fixed on the reflection surface for trapping the target substance.

According to another aspect of the present invention, in the target substance trapping unit, the reflection surface on which a target substance of the same type as the target substance, which is the subject to be detected, is fixed in a constant amount is brought into contact with a mixture of a target substance trapping substance, which specifically reacts with the target substance fixed on the reflection surface, in a known amount, the target substance that is the subject to be detected, and a sample containing the target substance that is the subject to be detected.

According to a third aspect of the present invention, a target substance detecting method includes: trapping a target substance on a reflection surface of a structure that has the reflection surface including concave portions and convex portions formed regularly on its surface, covered by a metal film, and reflecting light irradiated to the reflection surface; irradiating parallel light on the reflection surface that traps the target substance; obtaining a wavelength at an extreme value of the reflected light of the parallel light reflected on the reflection surface; and obtaining a concentration of the target substance based upon a shift of the obtained wavelength at the extreme value.

According to a fourth aspect of the present invention, a target substance detecting method includes: fixing a target substance of the same type as a target substance that is a subject to be detected, in a constant amount, on a reflection surface of a structure that has the reflection surface including concave portions and convex portions formed regularly on its surface, covered by a metal film, and reflecting light irradiated to the reflection surface; allowing a mixture of a target substance trapping substance, which specifically reacts with the target substance fixed on the reflection surface, in a known amount, and a sample containing the target substance that is the subject to be detected, to be brought into contact with the reflection surface; irradiating parallel light to the reflection surface with which the mixture is in contact; obtaining a wavelength at an extreme value of the reflected light of the parallel light reflected on the reflection surface; and obtaining a concentration of the target substance based upon a shift of the obtained wavelength at the extreme value.

According to another aspect of the present invention, the metal film is gold, and thickness thereof is 30 nm or more and 1000 nm or less.

According to another aspect of the present invention, the structure is a photonic crystal.

### Advantageous Effect of the Invention

The present invention can provide a target substance detecting apparatus and a target substance detecting method that can accurately detect a target substance.

### BRIEF DESCRIPTION OF DRAWINGS

FIG. 1 is a view illustrating a target substance detecting apparatus according to an embodiment of the present invention.

FIG. 2-1 is a plan view of a photonic crystal (structure).

FIG. 2-2 is a sectional view taken along line A-A in FIG. 2-1.

FIG. 2-3 is a view for describing a process of forming the photonic crystal.

FIG. 2-4 is a view for describing a process of forming the photonic crystal.

FIG. 2-5 is a view for describing a process of forming the photonic crystal.

FIG. 3-1 is a view for describing a principle of a photonic crystal biosensor serving as a target substance trapping unit.

FIG. 3-2 is a view for describing a principle of the photonic crystal biosensor serving as the target substance trapping unit.

FIG. 3-3 is a view for describing a principle of the photonic crystal biosensor serving as the target substance trapping unit.

FIG. 3-4 is a view for describing a principle of the photonic crystal biosensor serving as the target substance trapping unit.

FIG. 4 is a view illustrating the relationship between an intensity of the reflected light at an extreme value and a wavelength.

FIG. 5 is a view illustrating a relationship between a wavelength shift amount Δλ at an extreme value of the intensity of the reflected light and a concentration DN of avidin fixed on the reflection surface of the photonic crystal by use of biotin.

FIG. 6 is a perspective view of the photonic crystal biosensor according to the embodiment of the present invention.

FIG. 7-1 is a view for describing the photonic crystal biosensor according to the embodiment of the present invention.

FIG. 7-2 is a view for describing the photonic crystal biosensor according to the embodiment of the present invention.

FIG. 7-3 is a view for describing the photonic crystal biosensor according to the embodiment of the present invention.

FIG. 8-1 is a view for describing a manner of fixing the photonic crystal biosensor according to the embodiment of the present invention.

FIG. 8-2 is a view for describing a manner of fixing the photonic crystal biosensor according to the embodiment of the present invention.

FIG. 9-1 is a view for describing a marker according to the embodiment of the present invention.

FIG. 9-2 is a view for describing the marker according to the embodiment of the present invention.

FIG. 9-3 is a view for describing another marker according to the embodiment of the present invention, and illustrating a marker other than a houndstooth check.

FIG. 9-4 is a view for describing another marker according to the embodiment of the present invention, and illustrating a marker other than a houndstooth check.

FIG. 9-5 is a view for describing another marker according to the embodiment of the present invention, and illustrating a marker other than a houndstooth check.

FIG. 10-1 is a view for describing another marker according to the embodiment of the present invention.

FIG. 10-2 is a view for describing another marker according to the embodiment of the present invention.

FIG. 10-3 is a view for describing another marker according to the embodiment of the present invention.

FIG. 11 is a view illustrating another photonic crystal biosensor.

FIG. 12 is a view illustrating an example in which an optical detecting unit of the target substance detecting apparatus irradiates light to the photonic crystal biosensor.

FIG. 13 is a view illustrating a structure of a measurement probe of the optical detecting unit in the target substance detecting apparatus according to the embodiment of the present invention.

FIG. 14 is a view illustrating a result of the relationship between reflectivity and wavelength of the light irradiated to a metal film formed on the reflection surface of the photonic crystal, the relationship being measured with the thickness of the metal film being changed.

FIG. 15 is a view illustrating an evaluation condition of the optical detecting unit in the target substance detecting apparatus according to the embodiment of the present invention.

FIG. 16 is a view illustrating a structure of a bundle fiber.

FIG. 17 is a view illustrating an evaluation condition of the bundle fiber.

FIG. 18 is a view illustrating an evaluation result of the optical detecting unit according to the embodiment of the present invention.

FIG. 19 is a view illustrating the evaluation result of the optical detecting unit according to the embodiment of the present invention.

FIG. 20 is a view illustrating the evaluation condition of the bundle fiber.

FIG. 21 is a view illustrating the evaluation condition of the bundle fiber.

FIG. 22 is a view illustrating an example of an apparatus that evaluates an influence given to the wavelength shift at the extreme value by the difference in the refractive index.

FIG. 23 is a view illustrating an example of an apparatus that evaluates an influence given to the wavelength shift at the extreme value by the difference in the refractive index.

FIG. 24 is a flowchart illustrating a target substance detecting method according to the embodiment of the present invention.

FIG. 25-1 is a view for describing a principle of the photonic crystal biosensor serving as the target substance trapping unit according to the embodiment of the present invention.

FIG. 25-2 is a view for describing a principle of the photonic crystal biosensor serving as the target substance trapping unit according to the embodiment of the present invention.

FIG. 25-3 is a view for describing a principle of the photonic crystal biosensor serving as the target substance trapping unit according to the embodiment of the present invention.

FIG. 25-4 is a view for describing a principle of the photonic crystal biosensor serving as the target substance trapping unit according to the embodiment of the present invention.

FIG. 25-5 is a view for describing a principle of the photonic crystal biosensor serving as the target substance trapping unit according to the embodiment of the present invention.

### DESCRIPTION OF EMBODIMENTS

An embodiment (hereinafter referred to an exemplary embodiment) for embodying the present invention will be described in detail with reference to the drawings.

### First Embodiment

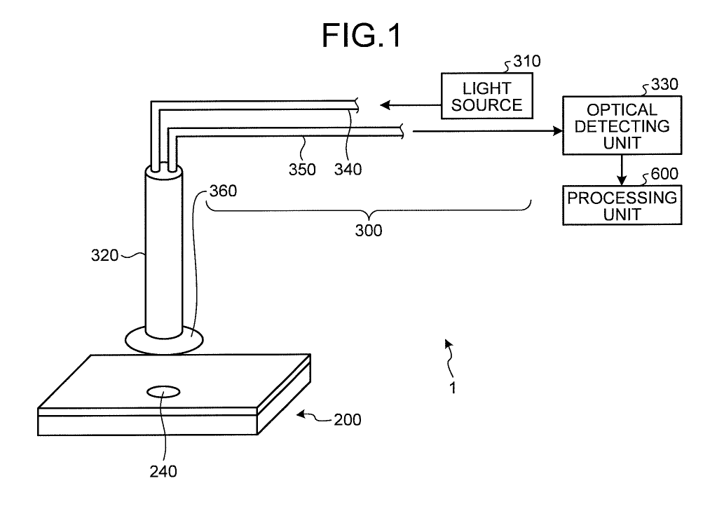

FIG. 1 is a view illustrating a target substance detecting apparatus according to the exemplary embodiment of the present invention. The target substance detecting apparatus 1 includes a photonic crystal biosensor 200 serving as a target substance trapping unit, an optical detecting unit 300, and a processing unit 600.

The photonic crystal biosensor 200 serving as the target substance trapping unit will firstly be described. The photonic crystal biosensor 200 serving as the target substance trapping unit is a structure that has a reflection surface including concave portions and convex portions regularly formed on its front surface, and from which a reflected light is obtained when light (parallel light) with a specific wavelength is irradiated to the reflection surface. The photonic crystal biosensor 200 serving as the target substance trapping unit may include a target substance trapping substance that is fixed on the reflection surface, and that traps the target substance.

The structure from which the reflected light is obtained with a specific wavelength when light is irradiated to the reflection surface on which the concave portions and convex portions are regularly formed is generally called a photonic crystal.

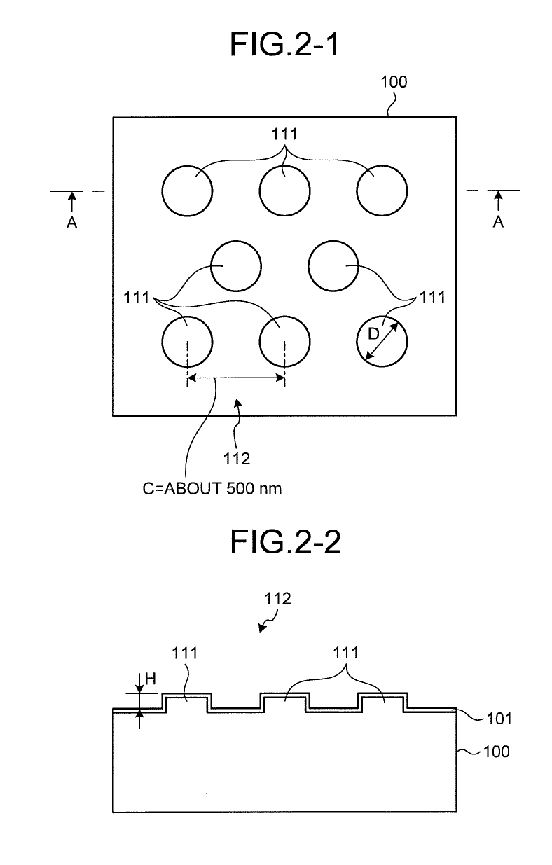

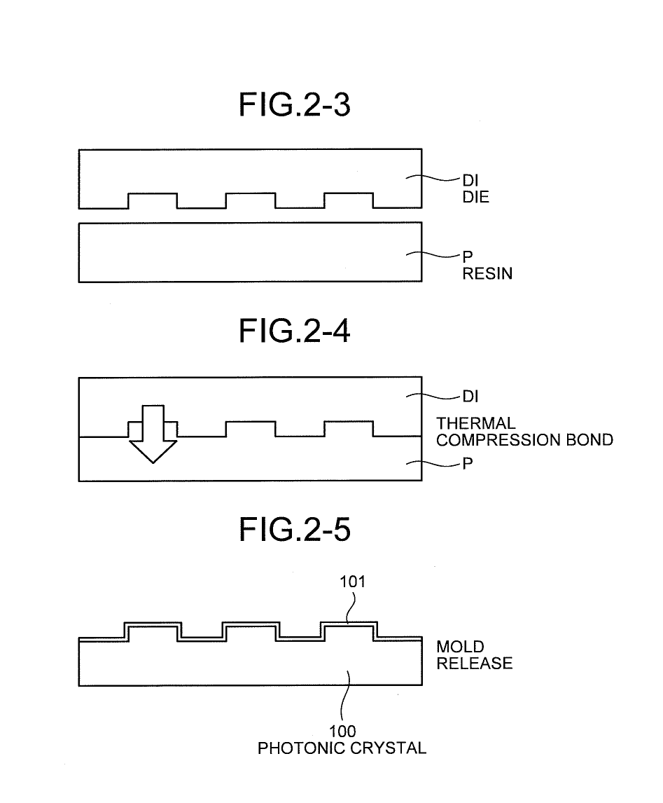

FIG. 2-1 is a plan view of the photonic crystal (structure). FIG. 2-2 is a sectional view taken along line A-A in FIG. 2-1. The photonic crystal biosensor 200 illustrated in FIG. 1 includes a photonic crystal 100. In general, the photonic crystal is a structure having a lattice structure of sub-wavelength interval. This structure reflects or transmits light of a specific wavelength that is dependent upon a shape and material of the photonic crystal, i.e., dependent upon a surface state of the photonic crystal, when light of broad wavelength range is irradiated to the surface (hereinafter referred to as a reflection surface) of the structure. The change in the surface state of the photonic crystal can be quantized by reading the change in the reflected light or transmitted light. Examples of the change in the surface state of the photonic crystal include an adsorption of substances on the surface, and structural change. In the photonic crystal having a metal thin film formed on its surface, when light is irradiated, an extreme value (maximum value or minimum value) appears on the reflectivity or transmittance of light. The extreme value of the reflectivity and transmittance depends upon a type of metal, thickness of the metal, or the surface shape of the photonic crystal. The change in the surface state of the photonic crystal can be quantized by reading the reflectivity or transmittance of light. The metal thin film will be described later. A method described below can be used for quantizing the change in the surface state of the photonic crystal based upon the change in the reflectivity or transmittance of light. For example, an amount of change of the reflectivity or transmittance, which is an extreme value (maximum value or minimum value), is obtained, or a shift amount of a wavelength by which the reflectivity or transmittance assumes the extreme value. If there are plural extreme values of the reflectivity or transmittance, an arbitrary extreme value is focused. The amount of change for the focused extreme value is obtained, or the shift amount of the wavelength by which the focused extreme value is obtained is acquired, whereby the change in the surface state of the photonic crystal can be quantized.

The photonic crystal 100 according to the exemplary embodiment of the present invention includes a reflection surface 112 on which convex portions 111 are regularly formed. The surface on which the convex portions 111 are regularly formed is the reflection surface 112 of the photonic crystal 100. When light is irradiated to the reflection surface 112, light of a specific wavelength dependent upon the shape and material of the photonic crystal 100 is reflected. In the present exemplary embodiment, a diameter D of the columnar convex portion 111 is about 250 nm. The distance C between the centers of the columnar convex portions 111 is about 500 nm. The columnar convex portions 111 are arranged in a triangular lattice. The height H of the columnar convex portion 111 is about 200 nm. It is preferable that the diameter D of the columnar convex portion 111 is 50 nm or more and 1000 nm or less. The distance C between the columnar convex portions 111 is preferably more than 100 nm and not more than 2000 nm. The size of the columnar convex portion 111 is not limited to those described above.

The shape and size of the photonic crystal 100 serving as the structure according to the present exemplary embodiment are not limited to those illustrated in FIGS. 2-1 and 2-2. For example, a photonic crystal having a fine pattern of rectangle or polygonal lattice formed thereon, a photonic crystal having a parallel-line pattern or waveform pattern formed thereon (specifically, having a pattern regularly formed thereon), or a photonic crystal having these patterns combined, may be used.

Examples of usable material of the photonic crystal 100 include an organic material such as a synthetic resin, and an inorganic material such as a metal or ceramic.

Examples of usable synthetic resin include thermoplastic resin such as polyethylene, polypropylene, polymethylpentene, poly cycloolefin, polyamide, polyimide, acryl, polymethacrylic acid ester, polycarbonate, polyacetal, polytetrafluoloethylene, polybutylene terephthalate, polyethylene terephthalate, polyvinyl chloride, polyvinylidene chloride, polystyrene, polyphenylene sulfide, polyether sulphone, or polyether ether ketone; and thermosetting resin such as phenolic resin, urea resin, or epoxy resin.

Examples of usable ceramic include silica, alumina, zirconia, titania, or yttria.

Various alloys such as a ferrous material can be used as the metal. Specifically, stainless steel, titanium, or titanium alloy can preferably be used.

Among various materials described above, poly cycloolefin synthetic resin or silica ceramic is more preferable from the viewpoint of an optical characteristic, processability, resistance to solution containing a target substance (a subject to be a target), adsorption of a target substance trapping substance (specific bonding substance), and resistance to cleaning agent. The poly cycloolefin synthetic resin is the most preferable, since it is excellent in processability.

The photonic crystal 100 is formed by performing microfabrication on the surface of the substrate made of the material described above. Examples of the process include a laser process, thermal nanoimprint, optical nanoimprint, and a combination of a photomask and etching. When the thermoplastic resin such as poly cycloolefin synthetic resin is used as the material, the thermal nanoimprint process is preferable.

In the present exemplary embodiment, as illustrated in FIG. 2-2, the surface (reflection surface 112) of the photonic crystal 100 is covered by a metal film 101. The metal film 101 is preferably made of Au (gold), Ag (silver), Pt (platinum), or Al (aluminum). The metal film 101 is made of Au in the present exemplary embodiment. Au is preferable for the reflection surface 112, since it has excellent stability. The metal film 101 can be formed on the surface of the photonic crystal 100 by use of a sputtering or vapor-deposition apparatus. The surface of the metal film 101 formed on the surface of the photonic crystal 100 serves as the reflection surface 112 of the photonic crystal 100. It is preferable that the outermost surface of the metal film 101 is made of Au.

The surface of the photonic crystal 100 is preferably reformed by using 3-triethoxysilylpropylamine (APTES). When the metal film 101 made of Au or Ag is formed on the surface of the photonic crystal 100, the surface of the photonic crystal 100 is preferably reformed by using a carbon chain having a thiol group at one end and a functional group such as an amino group or carboxyl group at the other end, not by using APTES. When the metal film 101 made of a metal other than Au and Ag is formed on the surface of the photonic crystal 100, the surface of the photonic crystal 100 is preferably reformed by using a silane coupling agent having a functional group at one end, such as APTES. Next, one example of a process of forming the photonic crystal 100 by a thermal nanoimprint will be described.

FIGS. 2-3, 2-4, and 2-5 are views for describing the process of forming the photonic crystal. In the thermal nanoimprint, a die DI having a fine structure of a nanometer level, or a periodic structure pattern of a nanometer level is used. The heated die DI is pressed against a sheet-type resin P so as to transfer the fine structure or periodic structure on the sheet-type resin P.

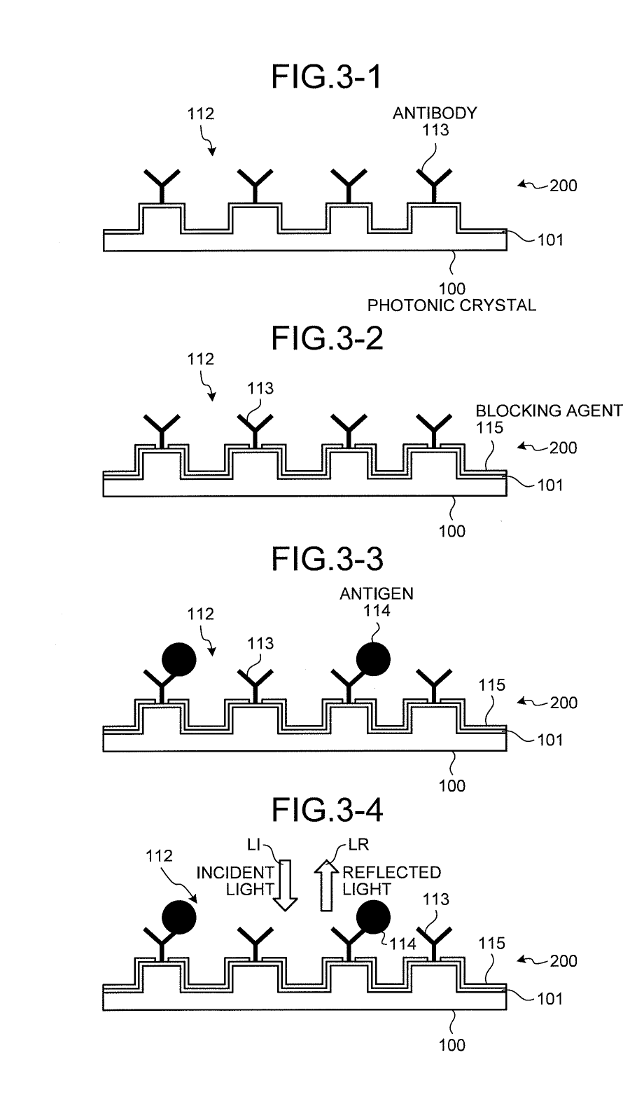

In the case of the cycloolefin polymer, it is preferable that the die DI is heated to about 160° C. (FIG. 2-3), pressed for a predetermined time with a pressure of about 12 MPa (FIG. 2-4), and released after the surface temperature of the die DI becomes about 60° C. After the resin P is released, the metal film 101 is formed on the surface that is in contact with the die DI by a sputtering or vapor-deposition apparatus (FIG. 2-5), whereby the photonic crystal 100 is completed.

The target substance trapping substance that traps the target substance will next be described. The target substance is a subject that is to be detected by the target substance detecting apparatus 1, and it may be any one of a polymer such as protein, oligomer, and low-molecular substance. The target substance is not limited to a monoatomic molecule, and it may be a complex made of plural molecules. A bioactive substance present in a living body is used as the target substance, for example, wherein cortisol is preferable. Cortisol is a low-molecular substance having a molecular weight of 362 g/mol. The concentration of cortisol in saliva increases, when a human feels stress. Therefore, the cortisol is focused as a substance for evaluating a degree of stress of a human. When the cortisol is used as the target substance, and its concentration is measured, e.g., when the concentration of the cortisol contained in saliva of a human is measured, the degree of stress can be evaluated.

The target substance trapping substance is a substance that binds to the target substance for trapping the target substance. To bind means not only the chemical binding, but also a binding not based upon the chemical binding, such as the binding with a physical adsorption or van der Waals binding. Preferably, the target substance trapping substance is the one that specifically binds to the target substance for trapping the target substance, and it is preferably an antibody to the target substance serving as an antigen. To specifically react means to selectively form a complex through a reversible or irreversible binding with the target substance. It is not limited to the chemical reaction. A substance, other than the target substance, which specifically reacts with the target substance trapping substance may also be present. Even if a sample includes a substance that reacts with the target substance trapping substance, other than the target substance, and when its affinity is extremely small compared to the target substance, the target substance can be quantized. Examples of usable target substance trapping substance include an antibody to the target substance serving as an antigen, an antibody artificially formed, a molecule made of a substance composing DNA, such as adenine, thymine, guanine, or cytosine, and peptide. When the target substance is cortisol, the target substance trapping substance is preferably a cortisol antibody.

Known methods can be employed for forming the target substance trapping substance. For example, an antibody can be formed by a serum method, hybridoma method, or phage display method. The molecule made of a substance composing the DNA can be prepared by, for example, SELEX (Systematic Evolution of Ligands by Exponential Enrichment). The peptide can be prepared by a phage display method, for example. The target substance trapping substance does not have to be labeled by any enzymes or isotopes. However, it may be labeled by enzymes or isotopes.

In the present exemplary embodiment, the target substance trapping substance is fixed on the reflection surface 112 of the photonic crystal 100. For example, an adsorption is employed as a process of fixing the target substance trapping substance onto the reflection surface 112 of the photonic crystal 100. The adsorption process is as described below, for example. Solution containing the target substance trapping substance is dripped onto the reflection surface 112 of the photonic crystal 100, whereby the target substance trapping substance is adsorbed on the reflection surface 112 for a predetermined time at room temperature, or for a predetermined time as cooled or heated according to need.

The target substance trapping unit allows an antibody (e.g., cortisol antibody) that is bonded only to a specific antigen (e.g., cortisol) to be adsorbed (fixed) beforehand on the surface of the photonic crystal 100. With this process, the photonic crystal biosensor 200 that detects a specific antigen can be formed. This utilizes the optical characteristic of the photonic crystal 100 and various chemical reactions within the body that occur on the surface or in the vicinity of the surface of the photonic crystal 100, e.g., the antigen-antibody reaction in which a specific antigen reacts with only a specific antibody.

The target substance trapping unit may be formed such that a blocking agent (protecting substance) is fixed on the reflection surface 112 of the photonic crystal 100 on which the antibody serving as the target substance trapping substance has already been fixed. The blocking agent is fixed before the target substance is in contact with the target substance trapping unit. The surface of the photonic crystal 100 is generally super-hydrophobic, and it may adsorb impurities other than the antibody serving as the target substance trapping substance by hydrophobic interaction. Since the optical characteristic of the photonic crystal 100 is greatly affected by the surface state, the detection accuracy is enhanced when the impurities are less adsorbed on the surface of the photonic crystal 100.

Therefore, it is preferable that a so-called blocking agent is fixed beforehand on the portion other than the portion where the antibody serving as the target substance trapping substance is adsorbed (fixed) in order to prevent the fixation of the impurities. In order to preliminarily adsorb the blocking agent, the blocking agent is brought into contact with the surface of the photonic crystal 100. Examples of usable blocking agent include skim milk, or bovine serum albumin (BSA). Next, a basic principle in which the photonic biosensor 200 serving as the target substance trapping unit detects the antigen serving as the target substance and its concentration will be described.

FIGS. 3-1, 3-2, 3-3, and 3-4 are views for describing the principle of the photonic crystal biosensor serving as the target substance trapping unit. In general, the photonic crystal biosensor 200 detects a small amount of protein or low-molecular substance by utilizing the optical characteristic of the photonic crystal 100 and various chemical reactions within the body that occur on the surface or in the vicinity of the surface of the photonic crystal 100, e.g., the antigen-antibody reaction in which a specific antigen reacts with only a specific antibody.

FIG. 3-1 illustrates the photonic crystal biosensor 200. Antibodies 113 are adsorbed and fixed on the surface (reflection surface 112) of the photonic crystal 100 of the photonic crystal biosensor 200. As described above, the surface of the Au metal film 101 covering the surface of the photonic crystal 100 is defined as the reflection surface 112.

As illustrated in FIG. 3-2, a blocking agent 115 (protecting substance) is preliminarily adsorbed in order that the impurities are not adsorbed on the portion of the reflection surface 112 other than the portion where the antibodies 113 are adsorbed. As illustrated in FIG. 3-3, antigens 114 are brought into contact with the photonic crystal biosensor 200 on which the antibodies 113 and the blocking agent 115 are adsorbed, in order to make an antigen-antibody reaction.

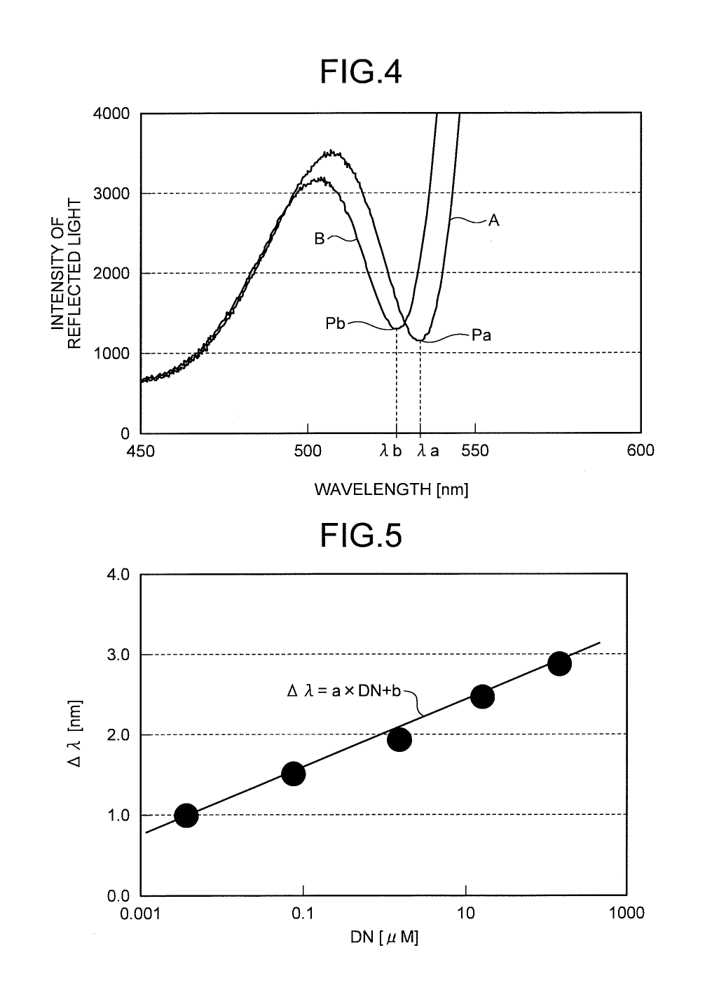

As illustrated in FIG. 3-4, light (incident light) LI with a specific wavelength is irradiated as parallel light with the antigens 114 being trapped by the antibodies 113 adsorbed on the reflection surface 112 of the photonic crystal 100. The wavelength at an extreme value of the reflected light LR reflected on the reflection surface 112 is obtained. With this process, the antigens 114 serving as the target substance are detected, or its concentration is obtained based upon the shift of the obtained wavelength at the extreme value. The optical detecting unit 300 in the target substance detecting apparatus 1 illustrated in FIG. 1 irradiates the light LI with a specific wavelength to the reflection surface 112 of the photonic crystal 100 as parallel light, and detects the reflected light LR from the reflection surface 112. The processing unit 600 obtains the wavelength at the extreme value of the intensity of the reflected light LR and the shift amount of the wavelength at the extreme value of the intensity, thereby detecting the antigens 114 or obtaining the concentration thereof.

The type of various biological materials or low-molecular materials, such as protein, which are subjects to be detected, can be changed by changing the type of the combination of antigen and antibody based upon the above-mentioned principle.

The present exemplary embodiment utilizes a phenomenon in which the extreme value of the wavelength of the reflected light is shifted due to the surface plasmon resonance and/or localized surface plasmon resonance upon the irradiation of light to the reflection surface 112 of the photonic crystal 100 having a nanostructure covered by the metal film 101. The present exemplary embodiment detects whether or not there is a target substance trapped on the reflection surface 112 of the photonic crystal 100, and detects the concentration of the target substance.

On the photonic crystal biosensor 200, the antigen 114 is trapped by the antibody 113 serving as the target substance trapping substance fixed on the reflection surface 112 of the photonic crystal 100, whereby the state of the reflection surface 112 is changed, and the change in the reflected light LR is observed. The photonic crystal biosensor 200 outputs an optical physical amount. This physical amount is correlated to the change in the surface state of the reflection surface 112 of the photonic crystal 100, and also correlated to the amount of complex whose antigen 114 is trapped by the antibody 113. Examples of the optical physical amount include the shift amount of the wavelength by which the intensity of the reflected light becomes an extreme value (maximum value or minimum value), an amount of change of the light reflectivity, the shift amount of the wavelength by which the light reflectivity becomes an extreme value (maximum value or minimum value), the intensity of the reflected light, and an amount of change of the extreme value of the intensity of the reflected light. In the present exemplary embodiment, the shift amount of the wavelength by which the intensity or reflectivity of the reflected light becomes the extreme value (maximum value or minimum value) is used.

The optical physical amount is outputted in the manner described below, for example. Light is orthogonally incident on the reflection surface 112 of the photonic crystal 100, and the reflected light is detected. Alternatively, light is incident with an angle to a perpendicular line of the reflection surface 112 of the photonic crystal 100, and the reflected light is detected. The detection of the reflected light can make the target substance detecting apparatus 1 illustrated in FIG. 1 compact. When the light that is perpendicularly incident, and perpendicularly reflected is detected, it is preferable that light is incident by using a bifurcated optical fiber so as to detect the reflected light. This structure will be described later.

FIG. 4 is a view illustrating the relationship between the extreme value of the intensity and the wavelength of the reflected light. FIG. 4 illustrates the intensity to the wavelength (spectrum) of the reflected light. The relationship of B in FIG. 4 indicates the relationship between the intensity and wavelength of the reflected light when there is only the metal film 101 on the reflection surface 112 of the photonic crystal 100. The relationship of A in FIG. 4 indicates the relationship between the intensity and wavelength of the reflected light when the antigen 114 is trapped by the antibody 113 fixed on the reflection surface 112 of the photonic crystal 100. In both cases, extreme values (minimum values) Pa and Pb of the intensity of the reflected light are obtained within the wavelength of 500 nm to 550 nm. The wavelengths in this case are λb, and λa (λb<λa). As illustrated in FIG. 4, when the antigen 114 is trapped by the antibody 113 fixed on the surface of the metal film 101 forming the reflection surface 112, the wavelength at the extreme value (minimum value) Pa is shifted to λa that is greater than in the case where there is only the metal film 101. In the present exemplary embodiment, the target substance is detected by using the shift amount (wavelength shift amount) Δλ(λa−λb) of the wavelength.

FIG. 5 is a view illustrating the relationship between the wavelength shift amount at the extreme value of the intensity of the reflected light and a concentration of avidin fixed on the reflection surface of the photonic crystal 100 by using biotin. In FIG. 5, the wavelength shift amount Δλ at the extreme value (minimum value) of the intensity of the reflected light is obtained when the biotin is fixed on the reflection surface 112 of the photonic crystal 100 as the target substance trapping substance, and avidin with a different concentration is dripped as the target substance. The wavelength shift amount Δλ is an amount of change (increasing amount) from the wavelength at the extreme value (minimum value) of the intensity of the reflected light when only the metal film 101 is present on the reflection surface 112 of the photonic crystal 100. As illustrated in FIG. 5, as the concentration DN of avidin serving as the target substance increases, the wavelength shift amount Δλ increases. It is found from FIG. 5 that the wavelength shift amount Δλ and the concentration DN of the dripped target substance are correlated to each other. The relationship between the wavelength shift amount Δλ and the concentration DN can be approximated by a linear equation of Δλ=a×DN+b (a, and b are constants). In the present exemplary embodiment, the concentration of the target substance trapped on the reflection surface 112 of the photonic crystal 100 is obtained by obtaining the wavelength shift amount Δλ. In the above description, biotin is used as the target substance trapping substance, and avidin is used as the target substance. However, the similar result is obtained in case where cortisol is used as the target substance, and cortisol antibody is used as the target substance trapping substance.

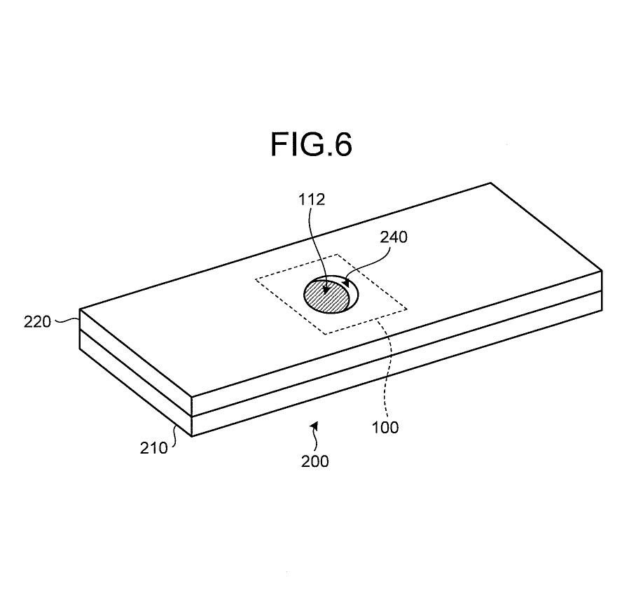

FIG. 6 is a perspective view illustrating the photonic crystal biosensor according to the present exemplary embodiment. FIGS. 7-1, 7-2, and 7-3 are explanatory views of the photonic crystal biosensor according to the present exemplary embodiment. The structure of the photonic crystal biosensor 200 will be described with reference to these figures. In the present exemplary embodiment, the photonic crystal biosensor 200 includes a lower plate 210, a plate 220 formed with an opening 240, and a photonic crystal 100, wherein the photonic crystal 100 is sandwiched between the lower plate 210 and the plate 220. The photonic crystal 100 in this case may have a shape other than the shape formed with the above-mentioned columnar convex portions 111.

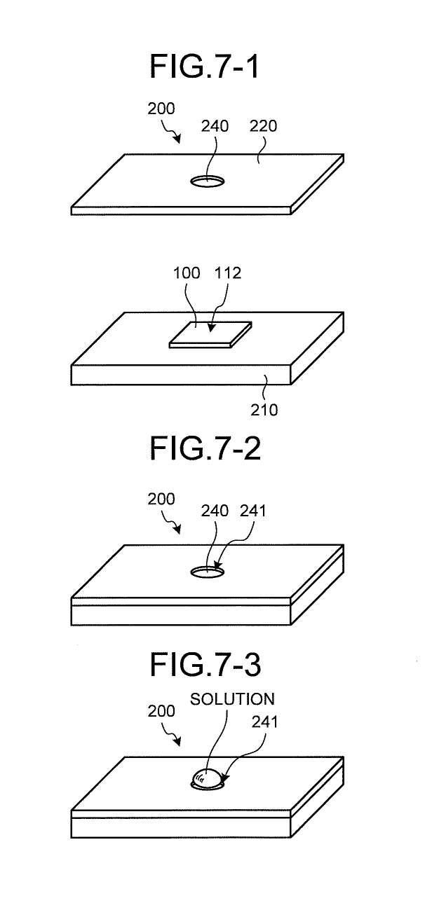

FIG. 7-2 illustrates the assembled photonic crystal biosensor 200. The end of the opening 240 on the lower plate 210 is closed by the reflection surface 112 of the photonic crystal 100. With this structure, the plate 220 has a concave portion 241 (liquid-droplet holding portion) that is enclosed by the inner wall of the opening 240 side and the reflection surface 112, and that has a fixed capacity. The inner wall of the opening 240 means the inner wall of the plate 220, which is a boundary surface between the plate 220 and the opening 240. FIG. 7-3 illustrates that predetermined solution is dripped in the concave portion 241 enclosed by the inner wall of the opening 240 and the reflection surface 112. In this case, the concave portion 241 enclosed by the inner wall of the opening 241 and the reflection surface 112 exhibits a liquid-droplet holding function, which prevents the solution from being flown out of the opening 240. When the solution is dripped in an amount that the solution spreads in the concave portion 241, the satisfactory detection and measurement of the target substance can be carried out.

The shape of the opening 240 is not limited to columnar as illustrated. Various shapes can be applied to the opening 240, so long as it has the liquid-droplet holding function. When the opening 240 is columnar, the diameter can be changed according to the type of the combination of the antigen and antibody, a required measurement accuracy, or an optical system of a detector of the reflected light. The diameter of the opening 240 is preferably 0.5 mm to 10 mm. More preferably, the diameter of the opening 240 is about 2 mm to 6 mm, in consideration of the operability and manageability during the rinsing operation and adsorption operation.

The materials for the plate 220 and the lower plate 210 are not particularly limited. Considering the cleanness of the surface, the plate 220 and the lower plate 210 made of stainless steel, poly cycloolefin resin, or silica are preferably used. Another photonic crystal biosensor 200 according to the present invention will next be described.

The plate 220 formed with the opening 240 illustrated in FIG. 7-1 can be made of a hydrophobic material. This structure can accurately collect solution on the concave portion 241 when hydrophilic solution, such as saliva, is detected and measured. The plate 220 can be made of a hydrophilic material, when lipophilic solution such as fat is detected and measured.

The plate 220 may be made of a water-repellent material, oil-repellant material, or a material having water-repellent property and oil-repellent property. A surface treatment or coating that exhibits hydrophobic property, hydrophilic property, water-repellent property, or oil-repellent property may be performed to the plate 220. This process can allow the solution to be accurately collected on the concave portion 241.

It is preferable that a fixing member (target-substance trapping unit fixing unit, photonic crystal biosensor fixing unit) for fixing the photonic crystal biosensor 200 on the position determined with respect to the optical detecting unit 300 illustrated in FIG. 1 is mounted below the photonic crystal biosensor 200. Examples of usable fixing member include a magnet sheet, a double-sided tape, and an adhesive agent. Instead of the fixing member, a vacuum chuck or a electrostatic chuck may be used as a fixing mechanism. Fixing the photonic crystal biosensor 200 can reduce a deviation in the measurement position caused by vibration during the detection and measurement. Accordingly, a more accurate detection and measurement can be carried out.

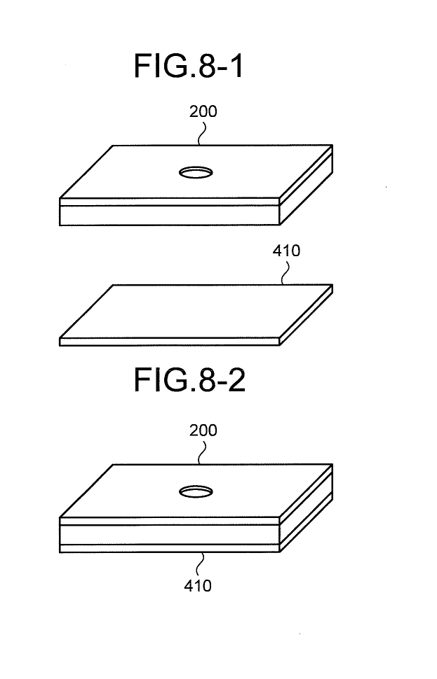

FIGS. 8-1, and 8-2 are views for describing the photonic crystal biosensor fixing unit according to the present exemplary embodiment. The photonic crystal biosensor 200 has a magnet sheet 410 attached thereto. FIG. 8-1 illustrates the state before the magnet sheet 410 is attached, and FIG. 8-2 illustrates the state after the magnet sheet 410 is attached. The magnet sheet 410 serves as the photonic crystal biosensor fixing unit.

The photonic crystal biosensor 200 is uniformly formed by thermal nanoimprint. However, if more accurate detection and measurement are expected, it is preferable that the light incident position or the position on which the light is reflected are accurately positioned considering the variation in the optical characteristic of the photonic crystal biosensor 200.

Specifically, the positional relationship between the photonic crystal biosensor 200 and a later-described measurement probe during the measurement after the antigen-antibody reaction and the positional relationship before the antigen-antibody reaction are preferably the same, and the same portion is preferably measured. Accordingly, the distance between the measurement probe and the reflection surface 112 of the photonic crystal biosensor 200 is preferably the same after the antigen-antibody reaction and before the antigen-antibody reaction. The distance is preferably fixed to be 50 to 500 μm. The photonic crystal biosensor 200 includes the plate 220. Therefore, the plate 220 functions as a spacer, whereby the distance between the measurement probe and the reflection surface 112 of the photonic crystal biosensor 200 can be made constant.

It is preferable that the photonic crystal biosensor 200 is marked with a positioning marker that displays the specific position on the reflection surface 112. The positioning marker can be formed by photolithography, sputtering, vapor deposition, lift-off process utilizing these techniques, printing by use of ink, or pattern formation by imprinting.

The marker can be formed on the front surface (on the reflection surface 112) or the back surface (the reverse side of the reflection surface 112) of the photonic crystal biosensor 200, so long as it can read the position. The marker may be formed on the photonic crystal 100 outside the measured portion of the photonic crystal 100. The marker may also be formed on the plate 220 or the lower plate 210 illustrated in FIGS. 6 and 7-1.

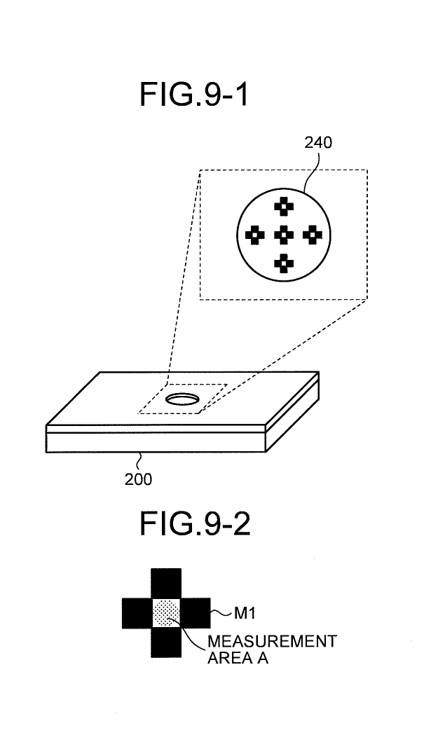

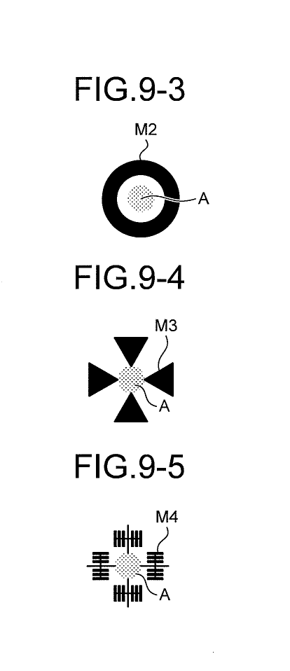

FIG. 9-1 is a view for describing a marker according to the present exemplary embodiment. FIG. 9-2 is an enlarged view of the marker according to the present exemplary embodiment. The photonic crystal biosensor 200 illustrated in FIG. 9-1 has the marker formed on the photonic crystal 100. FIG. 9-1 illustrates that five houndstooth markers M1 are formed on the portion of the photonic crystal 100 corresponding to the opening 240.

The central portion of each marker is defined as a measurement area A for measuring the reflected light. Specifically, in the photonic crystal biosensor 200 illustrated in FIG. 9-1, five measurement areas A are formed in the opening 240. Each measurement area A can accurately be positioned even after and before the antigen-antibody reaction. Therefore, more accurate detection and measurement can be carried out. When impurities are present in the measurement area A, the data of the intensity of the reflected light in the measurement area A having the impurities present therein is not used. Accordingly, more accurate detection and measurement can be carried out.

FIGS. 9-3, 9-4, and 9-5 are views illustrating another form of the marker according to the present exemplary embodiment, and illustrating markers having a shape other than the houndstooth shape. FIG. 9-3 illustrates an annular marker M2, FIG. 9-4 illustrates a marker M3 including plural triangles, wherein apexes of the respective triangles indicate the border of the measurement area A, and FIG. 9-5 illustrates a marker M4 including plural segments, wherein starting points of the respective segments indicate the border of the measurement area A.

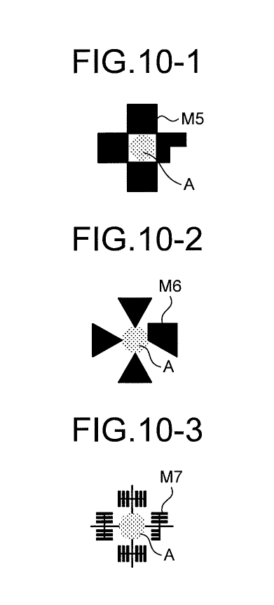

FIGS. 10-1, 10-2, and 10-3 are views illustrating another shape of the marker according to the present exemplary embodiment. A marker M5 illustrated in FIG. 10-1 includes three squares and one square whose part is missing, wherein the respective shapes are circumscribed with the border of the measurement area A. A marker M6 illustrated in FIG. 10-2 includes three triangles and one trapezoid, wherein apexes of the triangles indicate the border of the measurement area A. A marker M7 illustrated in FIG. 10-3 includes three congruent figures, each including plural segments, and one figure different from these figures, wherein the starting points of the segments indicate the border of the measurement area A. The markers M5, M6, and M7 have asymmetric shape, more specifically, have not line-symmetric axis. When the marker is formed to have an asymmetric shape, more specifically, the marker is formed not to have a line-asymmetric axis, positioning can accurately and easily be carried out after and before the antigen-antibody reaction. The front surface and the back surface of the photonic crystal 100 can be visually determined, or can be determined with a low magnification, whereby detection efficiency and measurement efficiency can be enhanced more.

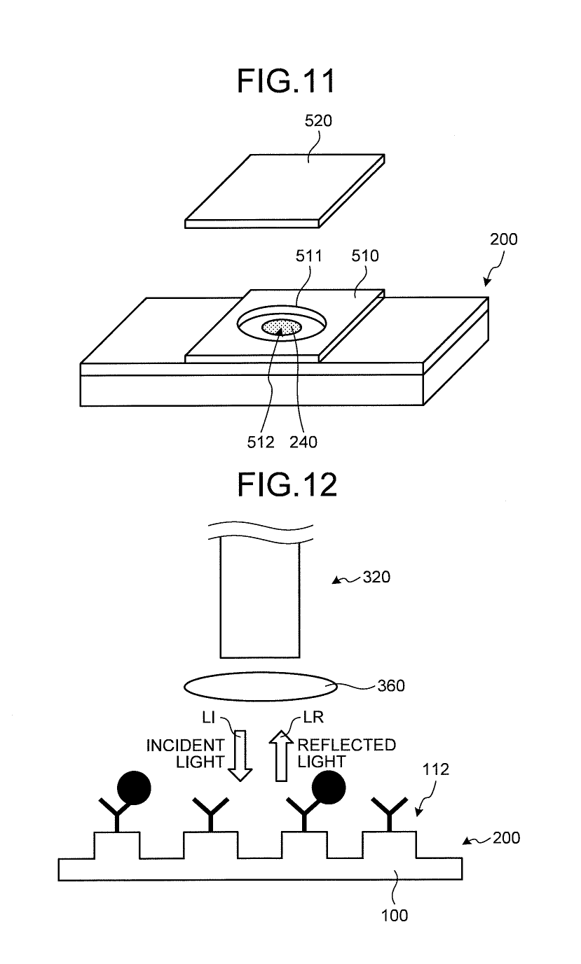

FIG. 11 is a view illustrating another photonic crystal biosensor. Another photonic crystal biosensor 200 will be described with reference to FIG. 11. The photonic crystal biosensor 200 has a member that closes the opening 240. The photonic crystal biosensor 200 has a structure of closing the opening 240 by a perforated cover 510 and a sheet 520. The perforated cover 510 is a plate member having an opening 511. The perforated cover 510 is used as superimposed on the photonic crystal biosensor 200.

The opening 511 is covered by the sheet 520 after the target substance is placed in a space 512 enclosed by the inner wall of the opening 511 of the perforated cover 510. In this case, the inner wall of the opening 511 of the perforated cover 510, the inner wall of the opening 240 of the photonic crystal biosensor 200, and the reflection surface 112 of the photonic crystal 100 form the liquid-droplet holding portion. The sheet 520 functions as a covering member. The inner wall of the opening 511 means the inner wall of the perforated cover 510, which is the border surface of the perforated cover 510 and the opening 511.

The perforated cover 510 and the sheet 520 can prevent evaporation of the solution dripped into the opening 240 of the photonic crystal biosensor 200, thereby being capable of suppressing the change in the concentration of the solution due to the evaporation during the antigen-antibody reaction. The perforated cover 510 and the sheet 520 also have an effect of preventing foreign matters from externally mixing into the solution.

Since the solution is filled in the space 512 formed by the perforated cover 510, the sheet 520, and the inner wall of the opening 240 of the photonic crystal biosensor 200, the reflected light can more accurately be measured with the solution being filled. In this case, the sheet 520 is preferably made of a transparent material, and more preferably, the sheet 520 is made of a material that absorbs less light of wavelength at the extreme value of the intensity of the reflected light. For example, silica is preferable for the material of the sheet 520, when the reflected light is measured within the range from a visible-light region to an ultraviolet region. The optical detecting unit 300 of the target substance detecting apparatus illustrated in FIG. 1 will next be described.

The optical detecting unit 300 of the target substance detecting apparatus illustrated in FIG. 1 includes a light source 310, a measurement probe 320, an optical detecting apparatus 330, a first optical fiber 340, a second optical fiber 350, and a collimator lens 360. The light source 310 and the measurement probe 320 are optically connected by the first optical fiber 340. The measurement probe 320 and the optical detecting apparatus 330 are optically connected by the second optical fiber 350. According to need, a control device may be provided that is connected to the light source 310 and the optical detecting apparatus 330, and that controls the light source 310 and processes a signal from the optical detecting apparatus 330.

FIG. 12 is a view illustrating an example in which the optical detecting unit of the target substance detecting apparatus irradiates light to the photonic crystal biosensor. The first optical fiber 340 guides the light from the light source 310 to the measurement probe 320, and irradiates the light from the measurement probe 320 to the reflection surface 112 of the photonic crystal 100 provided to the photonic crystal biosensor 200. The collimator lens 360 makes the light, emitted from the first optical fiber 340 and irradiated from the measurement probe 320, parallel light, and then, irradiates the parallel light to the reflection surface 112 of the photonic crystal 100 as incident light LI. The second optical fiber 350 receives the light reflected on the reflection surface 112 of the photonic crystal 100 as reflected light LR, and guides the reflected light to the optical detecting apparatus 330 serving as a light-receiving unit. The type of the collimator lens 360 is not particularly limited. For example, an antireflection film having a nanostructure can be used. The optical detecting apparatus 330 is an apparatus for detecting light, which is provided with a light receiving element such as phototransistor or CCD (Charge Coupled Device).

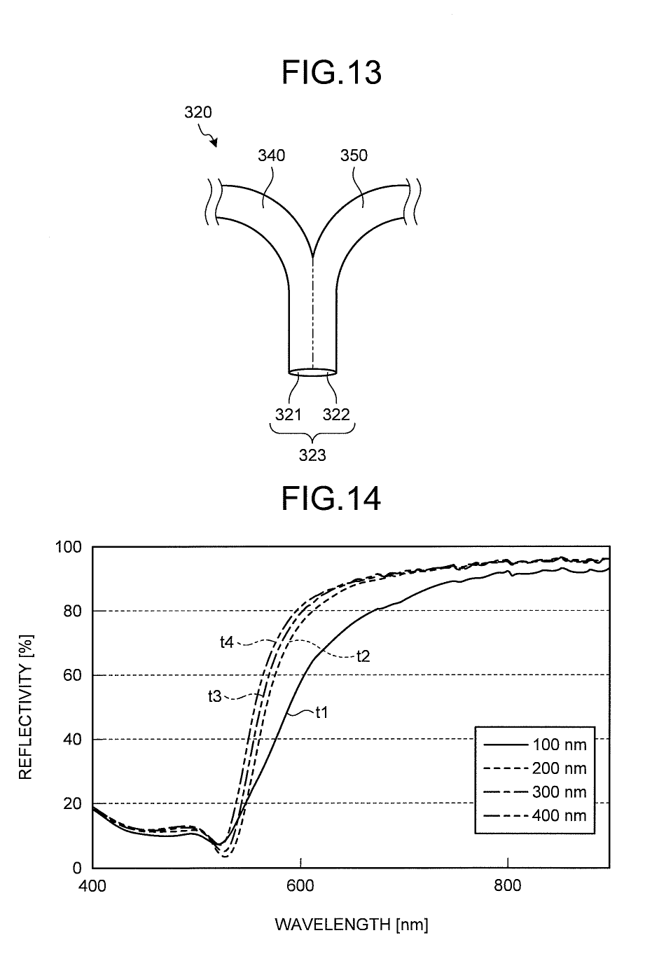

FIG. 13 is a view illustrating a structure of the measurement probe of the optical detecting unit in the target substance detecting apparatus according to the present exemplary embodiment. The measurement probe 320 is formed by bonding the first optical fiber 340 and the second optical fiber 350. In the measurement probe 320, an emission surface 321 of the first optical fiber 340 and an incident surface 322 of the reflected light of the second optical fiber 350 are arranged on the same surface (incident/emission surface) 323. As described above, the measurement probe 320 is formed such that the first optical fiber 340 and the second optical fiber 350 are integral on the emission side (emission surface 321 side) of the first optical fiber 340 and the incident side (incident surface 340 side) of the second optical fiber 350. The measurement probe 320 emits light and detects the reflected light LR by using the first optical fiber 340 and the second optical fiber 350.

With this structure, the measurement probe 320 can emit the incident light LI irradiated to the reflection surface 112 of the photonic crystal 100 of the photonic crystal biosensor 200 and can allow the reflected light LR from the reflection surface 112 to be incident thereon on almost the same position. The measurement probe 320 is configured as described above, and the light from the measurement probe 320 is made parallel by using the collimator lens 360. Therefore, the optical detecting unit 300 can allow the incident light LI that is the parallel light to be perpendicularly incident on the reflection surface 112. Further, the optical detecting unit 300 can receive the reflected light LR that is perpendicularly reflected on the reflection surface 112. With this structure, the measurement probe 320 can minimize the reduction in the intensity of the reflected light, and can mainly detect the component of 0^{th} order light of the reflected light LR. Accordingly, the correct information of the reflection surface 112 of the photonic crystal 100 can be acquired. As a result, the optical detecting unit 300 including the measurement probe 320 has enhanced detection accuracy of the target substance and the enhanced measurement accuracy of the concentration. The process of detecting the reflected light LR is not limited to the process of using the measurement probe 320. For example, a half mirror may be arranged between the collimator lens 360 and the reflection surface 112, and the reflected light LR may be separated by the half mirror to be guided to the optical detecting apparatus 330 from the second optical fiber 350. The thickness of the metal film 101 formed on the reflection surface 112 of the photonic crystal 100 will next be described.

FIG. 14 is a view illustrating the result of the relationship between the reflectivity and wavelength of the light irradiated to the metal film formed on the reflection surface of the photonic crystal, wherein the thickness of the metal film is changed. t1 is the result in the case of the thickness of 100 nm, t2 is the result in the case of the thickness of 200 nm, t3 is the result in the case of the thickness of 300 nm, and t4 is the result in the case of the thickness of 400 nm.

When the thickness of the metal film 101 is small, a part of the incident light to the photonic crystal 100 might transmit the metal film 101. As a result, an information amount acquired from the reflected light might be reduced, or a lot of unnecessary information might be included in the reflected light from the photonic crystal 100, such as diffraction light or the reflected light from the back surface of the photonic crystal 100. Increasing appropriately the thickness of the metal film 101 can reduce the unnecessary information included in the reflected light from the photonic crystal 100 so as to be capable of enhancing the detection accuracy of the target substance and the measurement accuracy of the concentration. When the thickness of the metal film 101 is appropriately small, a fine pattern can easily be formed on the front surface of the photonic crystal 100, thus preferable. For example, it becomes easy to secure the dimension of the pattern, since the corner of the pattern becomes sharp.

From this viewpoint, the thickness of the metal film 101 is preferably set to be 30 nm or more and 1000 nm or less, more preferably 150 nm or more and 500 nm or less in the present exemplary embodiment. From the result in FIG. 14, the change in the reflectivity to the wavelength is almost the same, as the thickness of the metal film 101 exceeds 200 nm. Therefore, it is more preferable that the thickness of the metal film 101 is set to be 200 nm or more and 400 nm or less. The evaluation result of the optical detecting unit 300 will next be described. As a comparative example, an evaluation result obtained when the incident light is irradiated, and the reflected light is received, by a bundle fiber will be described. A white light is used as the light to be irradiated. The reflectivity is a ratio to the intensity of the reflected light of the target substance (aluminum plate).

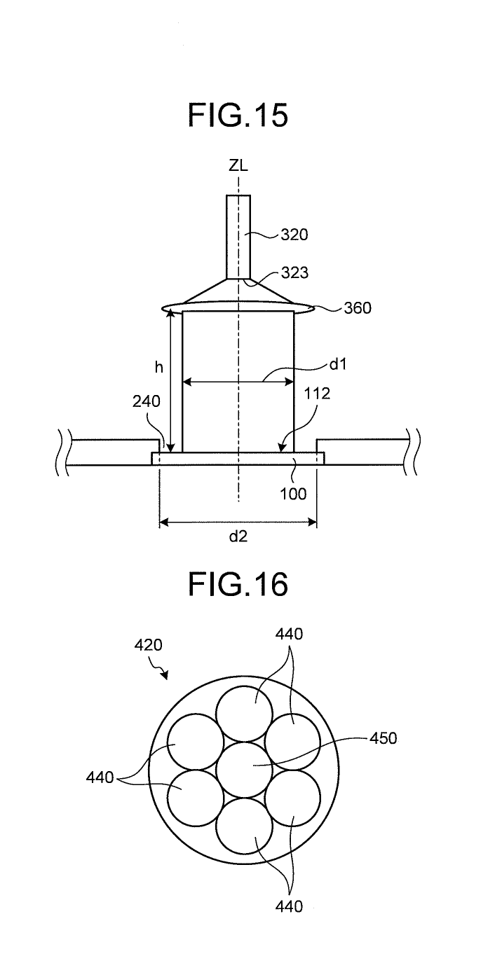

FIG. 15 is a view illustrating the evaluation condition of the optical detecting unit of the target substance detecting apparatus according to the present exemplary embodiment. As illustrated in FIG. 15, the optical detecting unit 300 includes the collimator lens 360 arranged between the emission surface of the measurement probe 320 and the reflected surface 112 of the photonic crystal 100. The distance (measured distance) between the collimator lens 360 and the reflection surface 112 is defined as h, the diameter of the parallel light, emitted from the collimator lens 360, on the reflection surface 112 is defined as d1, and the diameter of the opening 240 from which the reflection surface 112 of the photonic crystal 100 is exposed is defined as d2. In this evaluation, h is set as 15 mm or 40 mm, d1 is set as 3.5 mm, and d2 is set as 5 mm. The optical axis ZL of the light irradiated to the reflection surface 112 and the optical axis ZL of the reflected light reflected on the reflection surface 112 are orthogonal to the reflection surface 112. The diameter of the measurement probe 320 is 200 μm. A white light is used as the light to be irradiated. The reflectivity is a ratio to the intensity of the reflected light of the target substance (aluminum plate).

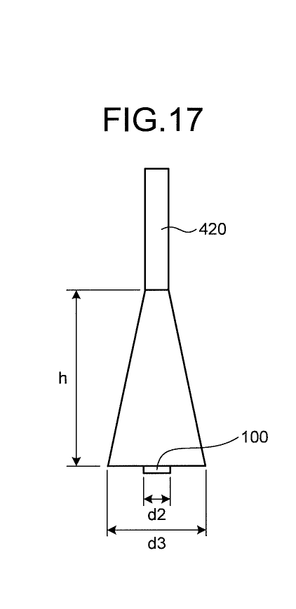

FIG. 16 is a view illustrating the structure of the bundle fiber. FIG. 17 is a view illustrating the evaluation condition of the bundle fiber. As illustrated in FIG. 16, a bundle fiber 420 is configured such that one light-receiving fibers 450 is enclosed by plural (six) irradiation optical fibers 440. The diameter of each of the irradiation optical fibers 440 and the diameter of the light-receiving optical fiber 450 are both 200 μm. As illustrated in FIG. 17, the distance (measured distance) between the bundle fiber 420 and the reflection surface 112 is set as h, the diameter of the light, emitted from the irradiation optical fiber 440, on the reflection surface 112 is set as d3, and the diameter of the opening 240 from which the reflection surface 112 of the photonic crystal 100 is exposed is set as d2. In this evaluation, h is set as 15 mm or 40 mm, d3 is set as 17.8 mm, and d2 is set as 5 mm.

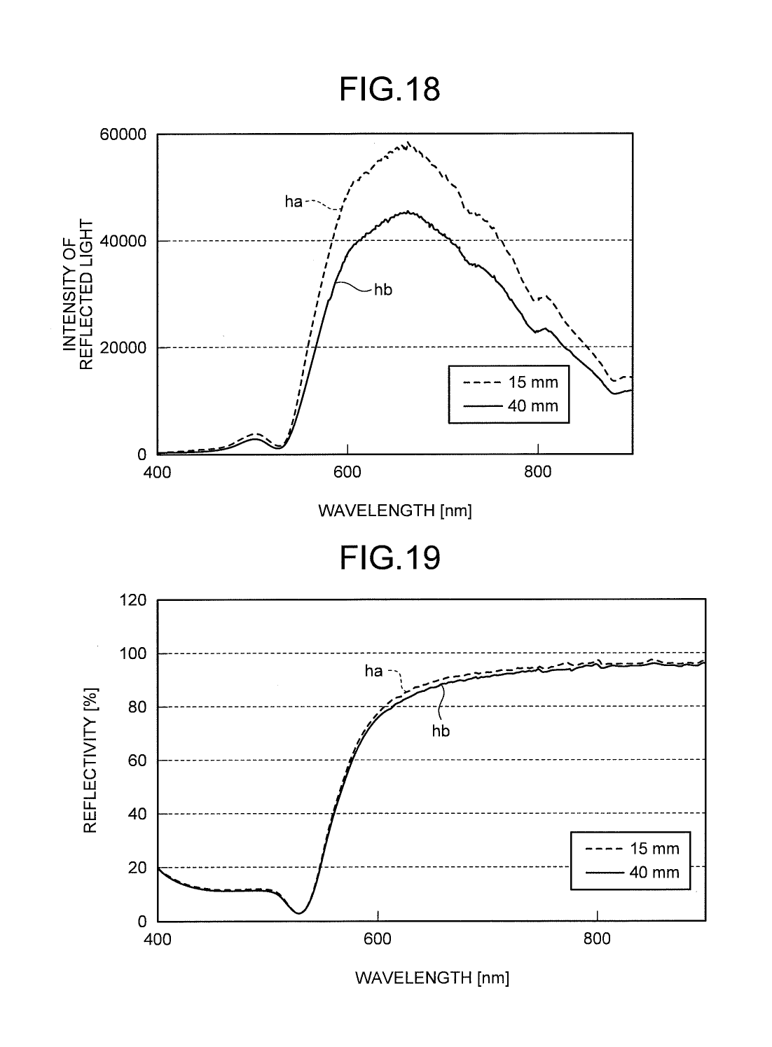

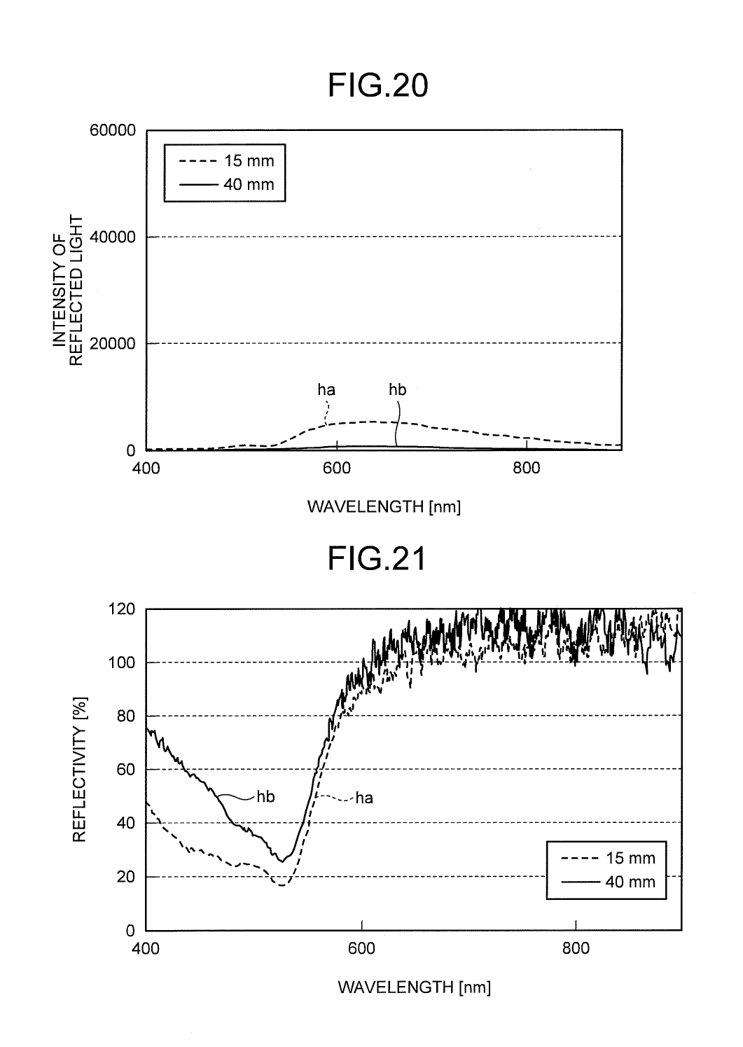

FIGS. 18 and 19 are graphs illustrating the evaluation result of the optical detecting unit according to the exemplary embodiment. FIGS. 20 and 21 are graphs illustrating the evaluation result of the bundle fiber. FIGS. 18 and 20 illustrate the intensity of the reflected light to the wavelength (spectrum) of the reflected light, while FIGS. 19 and 21 illustrate the reflectivity to the wavelength (spectrum) of the reflected light. In FIGS. 18 to 21, ha is the result in the case where the measured distance is 15 mm, while hb is the result in the case where the measured distance is 40 mm.

It is found from FIGS. 18 and 20 that the intensity of the reflected light of the optical detecting unit 300 is larger than that of the bundle fiber 420. This is considered because of the reason described below. Specifically, since the light emitted from the bundle fiber 420 diffuses with a certain angle, the intensity of the reflected light of the bundle fiber 420 becomes very small compared to the optical detecting unit 300 that irradiates parallel light. As understood from FIGS. 18 and 20, the intensity of the reflected light greatly depends upon the distance between the emission surface and the reflection surface 112, i.e., the measured distance h (robust property is low).

The reflectivity is calculated from the intensity of the reflected light. Therefore, the reflectivity is greatly affected by the magnitude of the intensity of the reflected light, and this influence appears as noise. The intensity of the reflected light of the optical detecting unit 300 that irradiates the parallel light is larger. Therefore, as illustrated in FIGS. 19 and 21, it is found that the optical detecting unit 300 has reduced noise component in the reflectivity, compared to the bundle fiber 420. As described above, the optical detecting unit 300 that irradiates the parallel light has enhanced detection accuracy of the target substance, enhanced accuracy of the measurement of concentration, and enhanced reliability, compared to the bundle fiber 420. Described next is the influence given to the wavelength shift at the extreme value by the difference in a refractive index of a substance interposed between the incident surface and receiving surface of light and the reflection surface 112 of the photonic crystal 100.

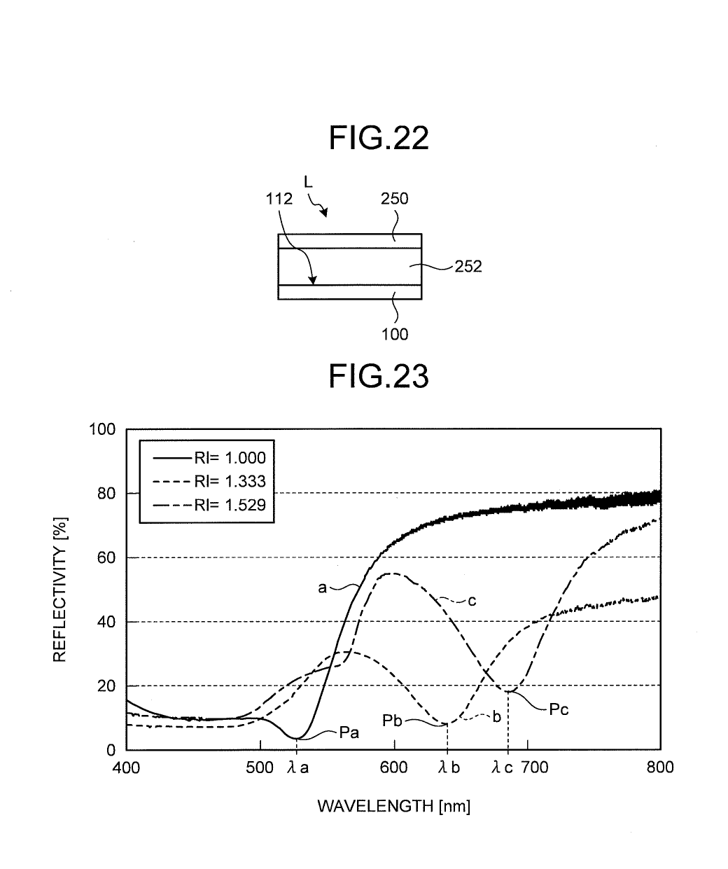

FIG. 22 is a view illustrating an apparatus for evaluating the influence of the difference in the refractive index to the wavelength shift. FIG. 23 is a view illustrating the result obtained by the evaluation of the influence of the difference in the refractive index to the wavelength shift. There is a method of “measuring liquid having different refractive index” as one of methods of evaluating sensitivity of a sensor. Refractive indexes of liquids A and B are defined as nα and nβ (nα>nβ), and peak wavelengths measured for the respective liquids are defined as λα, and λβ. The sensor sensitivity S in this case is S=(λβ−λα)/(nβ−nα) [nm/RIU (Refractive Index Unit)].

In the present exemplary embodiment, a material layer 252 with a thickness of about 2 mm is formed on the reflection surface 112 of the photonic crystal 100, and the material layer 252 is protected by a cover glass 250 having a thickness of about 0.2 mm, as illustrated in FIG. 22. The light L is irradiated to the reflection surface 112 from the cover glass 250, the reflected light is received, and the spectrum of the reflectivity is obtained. The example of the evaluation in the method of evaluating the sensitivity of the sensor described above is as illustrated in FIG. 23. In FIG. 23, a is the result in the case of refractive index RI=1.000 (air), b is the result in the case of refractive index RI=1.333 (water), and c is the result in the case of refractive index RI=1.529 (polyethylene imine aqueous solution). The wavelengths λa, λb, and λc of the reflected light at extreme values Pa, Pb, and Pc increase as the refractive index RI increases.

Au, Ag, Pt, and Al were evaluated as metals used for the metal film 101 on the surface of the photonic crystal 100 by using the method of evaluating the sensitivity of the sensor. As a result, when Ag, Pt, and Al were used for the metal film 101 on the surface of the photonic crystal 100, the wavelengths λa, λb, and λc of the reflected light at the respective extreme values Pa, Pb, and Pc were 1.5 times as large as those in the case where Au was used for the metal film 101. As described above, Ag, Pt, and Al have sensitivity 1.5 times larger than Au. It is preferable that an oxide thin film made of Au or SiO₂, which is difficult to be oxidized, is formed after the Ag is formed on the surface of the photonic crystal 100, since Ag is easy to be oxidized. In the present exemplary embodiment, Au film having a thickness of 5 nm was formed on the surface of the Ag film having a thickness of 200 nm. The sensitivity was obtained in this test. In the example in which the Au film with a thickness of 5 nm was formed on the surface of the Ag film with a thickness of 200 nm, the sensitivity was 1.5 times as large as the case where the Au film with a thickness of 200 nm was used. The change in the sensitivity was not observed depending upon the presence of the Au film with a thickness of 5 nm. It is preferable that an oxide thin film made of Au or SiO₂, which is difficult to be oxidized, is also formed after the Al is formed on the surface of the photonic crystal 100, since Al is easy to be oxidized like Ag. It is also preferable that the oxide thin film made of Au or SiO₂ is formed for the Pt in order to modify with the antibody.

The processing unit 600 in the target substance detecting apparatus 1 illustrated in FIG. 1 will next be described. The processing unit 600 obtains the wavelength at the extreme value of the reflected light detected by the optical detecting unit 300. Further, the processing unit 600 detects at least whether there is a target substance (e.g., the antigen 114 illustrated in FIGS. 3-3, and 3-4) or not based upon the wavelength shift (e.g., wavelength shift amount Δλ) at the extreme value. As described above, the wavelength shift amount Δλ and the concentration of the target substance trapped on the reflection surface 112 of the photonic crystal 100 are correlated to each other. Therefore, the processing unit 600 can obtain the concentration of the target substance trapped on the reflection surface 112 from the wavelength shift amount Δλ. The processing unit 600 is, for example, a microcomputer. Next, a method of detecting a target substance (target substance detecting method) by using the target substance detecting apparatus 1 will be described.

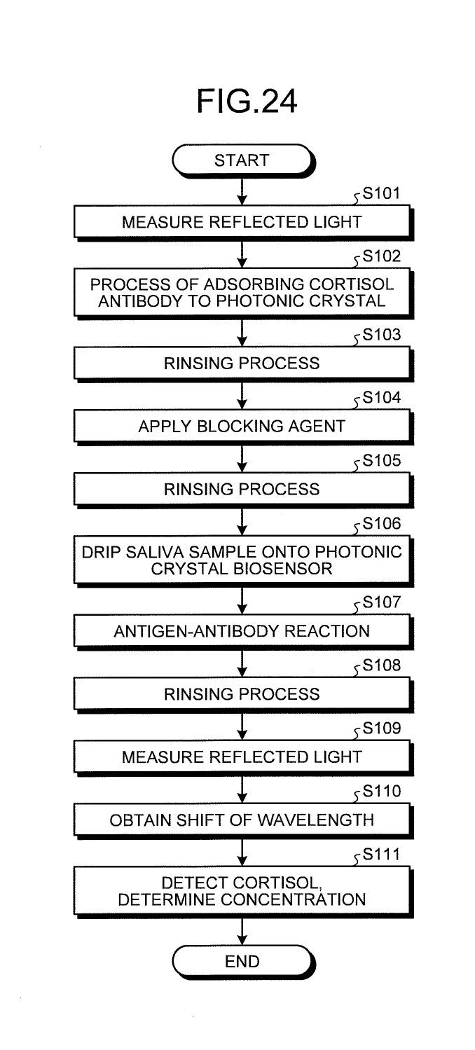

FIG. 24 is a flowchart illustrating the target substance detecting method according to the present exemplary embodiment. In this case, the surface of the metal film 101 formed on the surface of the photonic crystal 100 is defined as the reflection surface 112, the cortisol antibody is adsorbed on the reflection surface 112, and the detection and measurement are carried out by using the cortisol in saliva as the target substance that is the subject to be detected. A cycloolefin polymer sheet having formed thereon a predetermined fine pattern by thermal nanoimprint is cut into a predetermined size, and the resultant is used for the photonic crystal 100.

Firstly, the reflected light, e.g., the spectrum of the intensity of the reflected light, from the reflection surface 112 upon the irradiation of light to the reflection surface 112 is measured for the photonic crystal 100 by using a detector having a predetermined optical measurement system, i.e., the target substance detecting apparatus 1 (step S101). In this case, cortisol serving as the target substance is not trapped on the reflection surface 112. The metal film 101 is formed on the reflection surface 112. The wavelength of light irradiated to the reflection surface 112 is, for example, 300 nm or more and 900 nm or less.

Subsequently, cortisol antibody solution (cortisol antibody concentration 1 μg/ml to 50 μg/ml) is dripped onto the reflection surface 112 that is the surface of the photonic crystal 100. The photonic crystal 100 is left to stand for a predetermined time, or according to need, is left to stand for a predetermined time at predetermined temperature, in order to allow the cortisol antibody to be adsorbed on the reflection surface 112 that is the surface of the photonic crystal 100 (step S102).

Subsequently, phosphate buffered saline (PBS) is dripped on the reflection surface 112 that is the surface of the photonic crystal 100. Thereafter, a rising process for removing the PBS with centrifugal force is performed plural times (step S103).

Subsequently, skim milk is dripped on the reflection surface 112 of the photonic crystal 100 as the blocking agent 115. The photonic crystal 100 is left to stand for a predetermined time, or according to need, is left to stand for a predetermined time at predetermined temperature, in order to allow the skim milk to be adsorbed on the non-adsorption portion of the cortisol antibody on the reflection surface 112 of the photonic crystal 100 (step S104). Thereafter, a rising process is performed plural times by using phosphate buffered saline as described above (step S105). With the above-mentioned processes, a predetermined process is executed on the reflection surface 112 of the photonic crystal 100, whereby the photonic crystal biosensor 200 is formed.

Subsequently, saliva serving as solution containing cortisol is prepared. The preparation such as the sampling of saliva or removal of impurities is executed by using a commercially available saliva sampling kit. The preparation of saliva may be carried out on any timing before the saliva is dripped on the photonic crystal biosensor 200. For example, the preparation of saliva may be carried out before the photonic crystal biosensor 200 is formed, may be carried out simultaneous with the formation of the photonic crystal biosensor 200, or may be carried out after the intensity of the reflected light is measured.

Subsequently, the saliva to which the sampling and preparation have already been executed in an amount of 10 μL to 50 μL is dripped onto the photonic crystal biosensor 200 (step S106). The photonic crystal biosensor 200 is left to stand for a predetermined time, or according to need, is left to stand for a predetermined time at predetermined temperature, in order to perform the antigen-antibody reaction (step S107), and the rinsing process same as that described above is carried out plural times by using phosphate buffered saline (step S108).

Subsequently, light is irradiated to the reflection surface 112 of the photonic crystal biosensor 200 on which the cortisol has been adsorbed, by using the detector having the predetermined optical system, i.e., the target substance detecting apparatus 1, as in the process described above. The irradiated light is the same as the light irradiated to the reflection surface 112 at step S101. The target substance detecting apparatus 1 measures the reflected light from the reflection surface 112, e.g., the spectrum of the intensity of the reflected light (step S109).

The wavelength at the extreme value of the intensity of the reflected light from the photonic crystal biosensor 200 changes due to the influence from the antigen-antibody reaction on the reflection surface 112 or in the vicinity of the reflection surface 112. Therefore, the cortisol in the saliva can be detected from the difference, before and after the reaction, in the wavelength at the extreme value of the intensity of the reflected light, i.e., the wavelength shift amount Δλ. The concentration of the cortisol in the saliva can be detected from the wavelength shift amount Δλ.

Accordingly, the processing unit 600 in the target substance detecting apparatus 1 obtains the shift (wavelength shift amount Δλ) of the wavelength λ2 at the extreme value (minimum value) of the intensity (or reflectivity) of the reflected light measured at step S109 (step S110). The wavelength shift amount Δλ is the difference λ2−λ1 between the wavelength λ2 after the target substance is trapped on the reflection surface 112 and the wavelength λ1 corresponding to the extreme value (minimum value) of the intensity (or reflectivity) of the reflected light when the target substance is not trapped on the reflection surface 112.

The processing unit 600 determines that the saliva includes cortisol when the wavelength shift amount Δλ is not less than a predetermined amount (step S111). The processing unit 600 determines the concentration of the cortisol by using a relational expression between the wavelength shift amount Δλ and the concentration of the cortisol based upon the wavelength shift amount Δλ (step S111). The relational expression is obtained beforehand, and stored in the storage unit of the processing unit 600.

In the above-mentioned example, the wavelength shift amount Δλ is obtained by using the wavelength at the extreme value of the intensity of the reflected light on the reflection surface 112 on which the target substance is not trapped, but the invention is not limited thereto. For example, the wavelength shift amount Δλ may be obtained by using the wavelength at the extreme value of the intensity of the reflected light from the reflection surface 112 to which the rinsing process (step S103 or step S105) has already been performed. When there are plural extreme values at step S101 and step S109, the target extreme value is selected as needed. The wavelengths λ1 and λ2 are obtained for the selected extreme value.

The target substance detecting apparatus 1 can detect the target substance (in this example, cortisol) from at least solution. The target substance detecting apparatus 1 can also obtain the concentration of the target substance in the solution by using the relationship between the wavelength shift amount Δλ and the concentration of the target substance. In the present exemplary embodiment, light that is the parallel light is perpendicularly irradiated to the reflection surface 112 of the photonic crystal biosensor 200. Simultaneous with the irradiation, the target substance detecting apparatus 1 receives the reflected light perpendicularly reflected from the reflection surface 112, thereby detecting the target substance or obtaining the concentration. With this configuration, the detection accuracy of the target substance and the measurement accuracy of the concentration can be enhanced. As illustrated in FIGS. 7-1, 7-2, and 7-3, the photonic crystal biosensor 200 according to the present exemplary embodiment has the liquid-droplet holding function. Therefore, the necessary amount of the cortisol antibody solution, saliva, and rinse agent can remarkably be reduced.

### Second Embodiment

A second embodiment is different from the first embodiment in that a target substance in a constant amount is fixed on a reflection surface of a structure, and the reflection surface on which the target substance is fixed is brought into contact with a mixture of a target substance trapping substance, which specifically reacts with the target substance, in a known amount, the target substance that is the subject to be detected, and a sample. The second embodiment is the same as the first embodiment in that the target substance detecting apparatus detects the target substance and obtains the concentration of the target substance based upon the wavelength shift at the extreme value of the intensity or reflectivity of the reflected light.

FIGS. 25-1 to 25-5 are views for describing the principle of the photonic crystal biosensor serving as the target substance trapping unit according to the present exemplary embodiment. For example, an antigen-antibody reaction between cortisol and anti-cortisol antibody is considered as the specific reaction between an antibody 113 serving as the target substance trapping substance and an antigen 114 serving as the target substance. An IgG antibody serving as a receptor has a size of about 10 nm. The cortisol has a size of about 1 nm. When the cortisol that is the antigen 114 is fixed on a photonic crystal 100, and the IgG that is the antibody 113 is reacted, the change in the surface state of the photonic crystal 100 is greater than that in the case where the IgG antibody is fixed on the photonic crystal 100, and the cortisol that is the antigen is reacted. Therefore, the sensitivity of a photonic crystal biosensor 200 provided with the photonic crystal 100 described above increases.

An antibody (secondary antibody) to an antibody is used as a complex binding substance, and it is reacted with a complex 116 (see FIGS. 25-4, 25-5) fixed on the reflection surface 112 of the photonic crystal 100. With this process, the change in the surface state of the photonic crystal 100 greatly changes. As a result, the sensitivity of the photonic crystal biosensor 200 is enhanced. The secondary antibody can be used as unchanged, or a secondary antibody to which other substance is added may be used. As the secondary antibody serving as the complex binding substance is larger, the change in the surface state of the photonic crystal 100 increases, so that the sensitivity of the photonic crystal biosensor 200 increases.

In this case, after the complex (first complex) 116 is formed on a reflection surface 112 of the photonic crystal 100, the complex binding substance (e.g., secondary antibody) that specifically reacts with the first complex 116 is brought into contact with the reflection surface 112 of the photonic crystal 100 in an amount exceeding the amount of the first complex 116. Then, the first complex 116 is completely converted into the second complex. Thereafter, the photonic crystal biosensor 200 outputs a physical amount (in the present exemplary embodiment, the wavelength at the extreme value of the intensity or reflectivity of the reflected light) correlated to the amount of the second complex. With this process, the second complex is detected and quantized. The amount of the second complex is the same as the amount of the first complex 116. Therefore, the first complex 116 can be quantized.

As illustrated in FIGS. 25-1 and 25-2, in the photonic crystal biosensor 200 according to the present exemplary embodiment, the surface of the metal film 101 formed on the surface of the photonic crystal 100 is defined as the reflection surface 112, and the antigen 114 in a constant amount serving as the target substance is fixed on the reflection surface 112. The reflection surface 112 on which the antigen 114 is fixed is brought into contact with a mixture M of the antibody 113 in a known amount that specifically reacts with the antigen 114 and that serves as the target substance trapping substance. The photonic crystal biosensor 200 outputs the physical amount correlated to the amount of the complex 116 made of the antigen 114 and the antibody 113 fixed on the reflection surface 112, and correlated to the change in the surface state of the reflection surface 112.

The antigen 114 serving as the target substance is fixed on the reflection surface 112 of the photonic crystal 100. Since the photonic crystal 100 has the metal film 101 formed on its surface, it is preferable that the reflection surface 112 that is the surface of the metal film 101 is reformed by using a carbon chain having a thiol group at one end and a functional group such as an amino group or carboxyl group at the other end. When the metal film 101 made of a metal other than Au or Ag is formed on the surface of the photonic crystal 100, it is preferable that the reflection surface 112 of the photonic crystal 100 is reformed by using silane coupling agent having a functional group at one end, such as APTES. Examples of the process of fixing the antigen 114 on the reflection surface 112 of the photonic crystal 100 include a chemical binding process and physical binding process such as a covalent binding, chemical adsorption, or physical adsorption. These processes can appropriately be selected according to the property of the antigen 114. For example, when the adsorption is selected as the process of fixing the antigen, the process described below is executed. For example, solution containing the antigen 114 is dripped on the reflection surface 112 of the photonic crystal 100, whereby the antigen 114 is adsorbed on the reflection surface 112 for a predetermined time at room temperature, or according to need, for a predetermined time as cooled or heated.

The amount of the antigen 114 fixed on the photonic crystal 100 is constant. With this process, when the antigen 114 to be fixed and the antibody 113 serving as the target substance trapping substance form the complex 116, the photonic crystal biosensor 200 can output the physical amount correlated to the amount of the formed complex 116. The constant amount of the antigen 114 to be fixed may appropriately be changed. For example, the amount can be set to be an optimum amount depending upon the range of the amount of the antigen 114 contained in a sample S.

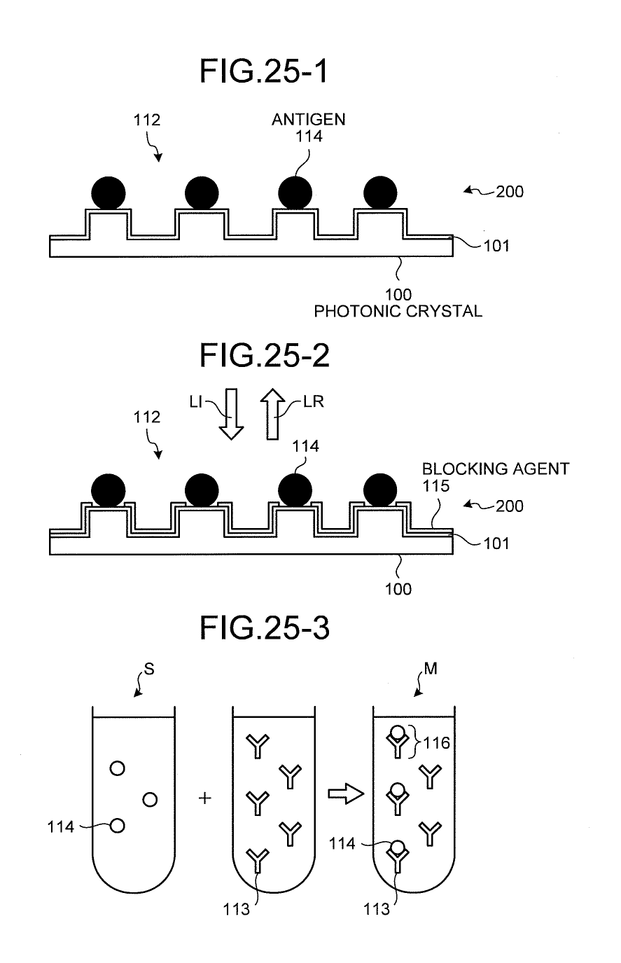

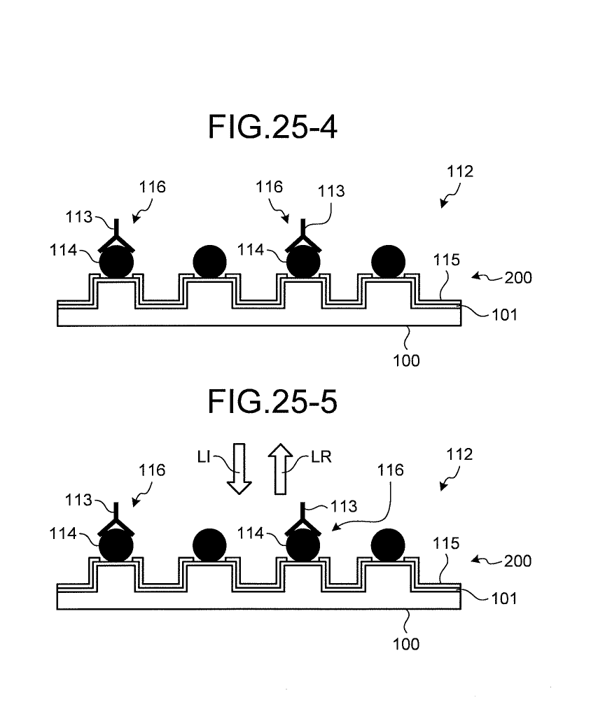

The photonic crystal 100 may be formed such that a blocking agent (protecting substance) 115 is fixed on the reflection surface 112 on which the antigen 114 is fixed as illustrated in FIG. 25-2. The blocking agent 115 is fixed before the antibody 113 is brought into contact with the reflection surface 112. The surface of the photonic crystal 100, i.e., the reflection surface 112, is generally super-hydrophobic. Therefore, the reflection surface might adsorb impurities other than the antibody 113 due to the hydrophobic interaction. Since the optical characteristic of the photonic crystal 100 is greatly affected by the surface state, it is preferable that the impurities are less adsorbed on the reflection surface 112 of the photonic crystal 100. By virtue of this, the detection accuracy can be enhanced.

Therefore, it is preferable that the so-called blocking agent 115 is preliminarily fixed on the portion other than the portion where the antigen 114 is adsorbed (fixed) in order to prevent the impurities from being fixed. In order to adsorb the blocking agent 115 beforehand, the blocking agent 115 is brought into contact with the surface of the photonic crystal 100. Examples of usable blocking agent 115 include skim milk, or bovine serum albumin (BSA).

The detection and quantization of the antigen 114 are executed based upon the optical physical amount outputted from the photonic crystal biosensor 200, e.g., based upon the shift amount of the wavelength by which the light intensity becomes the extreme value, or the shift amount of the wavelength by which the light reflectivity becomes the extreme value. The detection and quantization (e.g., the determination of concentration) of the antigen 114 executed based upon the shift amount of the wavelength by which the light reflectivity becomes the extreme value will be carried out as described below.

As illustrated in FIG. 25-1, the antigen 114 in a constant amount is fixed on the reflection surface 112 of the photonic crystal 100, and as illustrated in FIG. 25-2, the reflection surface 112 is fixed by the blocking agent 115. Then, light (incident light) LI of 300 nm or more and 900 nm or less is irradiated to the reflection surface 112 of the photonic crystal 100 as parallel light in such a manner that the optical axis is orthogonal to the reflection surface 112. The wavelength by which the intensity (or reflectivity) of the reflected light LR in this case becomes the extreme value (in this example, the minimum value) is defined as λ1.

Subsequently, a mixture M of the sample S and the antibody 113 in a known amount illustrated in FIG. 25-3 is brought into contact with the reflection surface 112 of the photonic crystal biosensor 200, so as to form the complex 116 on the reflection surface as illustrated in FIG. 25-4. Thereafter, the light (incident light) LI of 300 nm or more and 900 nm or less is irradiated to the reflection surface 112 of the photonic crystal biosensor 200 as parallel light in such a manner that the optical axis is orthogonal to the reflection surface 112. The wavelength by which the intensity (or reflectivity) of the reflected light LR in this case becomes the extreme value (in this example, the minimum value) is defined as λ2.

When the second complex is formed on the reflection surface 112, light is irradiated to the reflection surface on which the second complex has already been formed. The wavelength by which the intensity (or reflectivity) of the reflected light in this case becomes the extreme value (in this example, the minimum value) is defined as λ2. If there are plural extreme values, the target extreme value is selected as needed. The wavelengths λ1 and λ2 are obtained for the selected extreme value.

The wavelength shift amount Δλ of the wavelength by which the light reflectivity becomes the extreme value is λ2−λ1. The wavelength shift amount Δλ changes according to the change in the surface state of the reflection surface 112 of the photonic crystal 100. The antigen 114 is detected and quantized based upon Δλ. The quantization (in this example, the determination of the concentration of the antigen 114) of the antigen 114 will next be described.

It is supposed that the amount of the binding portion of the antigen 114 contained in the sample S is defined as X, and the known amount of the antibody 113 is defined as C. In this case, X<C is established. In the mixture M, the antigen 114 and the antibody 113 cause the antigen-antibody reaction to form the complex 116. Since X<C, the amount of the antibody 113 in the mixture M becomes C−X. When the mixture M is brought into contact with the reflection surface 112 on which the antigen 114 in a constant amount is fixed, the antibody 113 in the mixture M causes the antigen-antibody reaction with the antigen 113 on the reflection surface 112, whereby the complex 116 is formed. The amount of the antigen 114 fixed on the reflection surface 112 is not less than C−X of the amount of the antibody 113 in the mixture M.

When all antibodies in the mixture M cause the antigen-antibody reaction with the antigens 114 on the reflection surface 112, the amount of the complex 116 becomes C−X. The wavelength shift amount Δλ obtained from the wavelengths λ1 and λ2 that are measured after and before the mixture M is brought into contact with the reflection surface 112 corresponds to the amount of the complex 116 fixed on the reflection surface 112. Accordingly, Δλ=k×(C−X) is established, wherein k is a constant for converting the wavelength shift amount Δλ into the amount of the complex 116. The relationship between the amount of the complex 116 fixed on the reflection surface 112 and the wavelength shift amount Δλ is determined beforehand. The amount X of the antigen 114 can be obtained from C−Δλ/k according to the above-mentioned relational expression. The concentration of the antigen 114 can be obtained based upon the amount X of the antigen 114.

The exemplary first and second embodiments have been described above. However, the exemplary first and second embodiments are not limited to those described above. The components in the above-mentioned first and second embodiments include those that can easily be arrived by a person skilled in the art, those substantially equal, and equivalents.

### REFERENCE SIGNS LIST

1 TARGET SUBSTANCE DETECTING APPRATUS
100 PHOTONIC CRYSTAL
101 METAL FILM
111 CONVEX PORTION
112 REFLECTION SURFACE
113 ANTIBODY
114 ANTIGEN
115 BLOCKING AGENT
116 COMPLEX
200 PHOTONIC CRYSTAL BIOSENSOR
300 OPTICAL DETECTING UNIT
310 LIGHT SOURCE
320 MEASUREMENT PROBE
321 EMISSION SURFACE
322 INCIDENT SURFACE
323 INCIDENT/EMISSION SURFACE
330 OPTICAL DETECTING APPARATUS
340 FIRST OPTICAL FIBER
350 SECOND OPTICAL FIBER
360 COLLIMATOR LENS
600 PROCESSING UNIT
M1, M2, M3, M4, M5, M6, M7 MARKER

1. A target substance detecting apparatus comprising:
a target substance trapping unit configured to include a structure, which has a reflection surface including concave portions and convex portions formed regularly on its surface, covered by a metal film, and trapping a target substance, the structure reflecting light irradiated to the reflection surface;
an optical detecting unit configured to irradiate parallel light to the reflection surface, and to detect reflected light of the parallel light reflected on the reflection surface; and
a processing unit configured to obtain a wavelength at an extreme value of the reflected light detected by the optical detecting unit, and to detect at least whether the target substance is present or not based upon a shift of the obtained wavelength at the extreme value.

2. The target substance detecting apparatus according to claim 1, wherein
the target substance trapping unit includes a target substance trapping substance that is fixed on the reflection surface for trapping the target substance.

3. The target substance detecting apparatus according to claim 1, wherein
in the target substance trapping unit, the reflection surface on which a target substance of the same type as the target substance, which is the subject to be detected, is fixed in a constant amount is brought into contact with a mixture of a target substance trapping substance, which specifically reacts with the target substance fixed on the reflection surface, in a known amount, the target substance that is the subject to be detected, and a sample containing the target substance that is the subject to be detected.

4. The target substance detecting apparatus according to claim 1, wherein
the outermost surface of the metal film is gold.

5. The target substance detecting apparatus according to claim 4, wherein
the thickness of the metal film is 30 nm or more and 1000 nm or less.

6. The target substance detecting apparatus according to claim 1, wherein
the optical detecting unit comprises:
a first optical fiber that guides the light from the light source;
a collimator lens that makes the light emitted from the first optical fiber the parallel light; and
a second optical fiber that receives the reflected light, and guides the received light to a light-receiving unit.

7. The target substance detecting apparatus according to claim 6, wherein
the first optical fiber and the second optical fiber are integral on an emission side of the first optical fiber and an incident side of the second optical fiber.

8. The target substance detecting apparatus according to claim 1, wherein
the structure is a photonic crystal.

9. A target substance detecting apparatus comprising:
a target substance trapping unit configured to include a photonic crystal, which has a reflection surface including concave portions and convex portions formed regularly on its surface, covered by a metal film, and trapping a target substance, the structure reflecting light irradiated to the reflection surface;
an optical detecting unit configured to irradiate parallel light to the reflection surface, and to detect reflected light of the parallel light reflected on the reflection surface; and
a processing unit configured to obtain a wavelength at an extreme value of the reflected light detected by the optical detecting unit, and to obtain a concentration of the target substance based upon a shift of the obtained wavelength at the extreme value.

10. The target substance detecting apparatus according to claim 9, wherein
the target substance trapping unit includes a target substance trapping substance that is fixed on the reflection surface for trapping the target substance.

11. The target substance detecting apparatus according to claim 9, wherein
in the target substance trapping unit, the reflection surface on which a target substance of the same type as the target substance, which is the subject to be detected, is fixed in a constant amount is brought into contact with a mixture of a target substance trapping substance, which specifically reacts with the target substance fixed on the reflection surface, in a known amount, the target substance that is the subject to be detected, and a sample containing the target substance that is the subject to be detected.

12. A target substance detecting method comprising:
trapping a target substance on a reflection surface of a structure that has the reflection surface including concave portions and convex portions formed regularly on its surface, covered by a metal film, and reflecting light irradiated to the reflection surface;
irradiating parallel light on the reflection surface that traps the target substance;
obtaining a wavelength at an extreme value of the reflected light of the parallel light reflected on the reflection surface; and
obtaining a concentration of the target substance based upon a shift of the obtained wavelength at the extreme value.

13. A target substance detecting method comprising:
fixing a target substance of the same type as a target substance that is a subject to be detected, in a constant amount, on a reflection surface of a structure that has the reflection surface including concave portions and convex portions formed regularly on its surface, covered by a metal film, and reflecting light irradiated to the reflection surface;
allowing a mixture of a target substance trapping substance, which specifically reacts with the target substance fixed on the reflection surface, in a known amount, and a sample containing the target substance that is the subject to be detected, to be brought into contact with the reflection surface;
irradiating parallel light to the reflection surface with which the mixture is in contact;
obtaining a wavelength at an extreme value of the reflected light of the parallel light reflected on the reflection surface; and
obtaining a concentration of the target substance based upon a shift of the obtained wavelength at the extreme value.

14. A target substance detecting method according to claim 12, wherein
the metal film is gold, and thickness thereof is 30 nm or more and 1000 nm or less.

15. A target substance detecting method according to claim 12, wherein
the structure is a photonic crystal.

16. A target substance detecting method according to claim 13, wherein
the metal film is gold, and thickness thereof is 30 nm or more and 1000 nm or less.

17. A target substance detecting method according to claim 13, wherein
the structure is a photonic crystal.
